(19) United States
(12) Patent Application Publication
(10) Pub. No.: US 2026/0022078 A1
(43) Pub. Date: Jan. 22, 2026

(54) LAMINATE COMPRISING A LAYER OF A LAYERED MINERALIC MATERIAL AND A POLYURETHANE LAYER

(71) Applicant: BASF SE, Ludwigshafen am Rhein (DE)

(72) Inventors: Maike DAHLE, Lemfoerde (DE); Sebastian KOCH, Lemfoerde (DE); Andreas EMGE, Lemfoerde (DE); Michael FADER, Lemfoerde (DE)

(73) Assignee: BASF SE, Ludwigshafen am Rhein (DE)

(21) Appl. No.: 18/995,534

(22) PCT Filed: Jul. 19, 2023
(86) PCT No.: PCT/EP2023/070000

§ 371 Date: Jan. 16, 2025

(30) Foreign Application Priority Data
Jul. 20, 2022 (EP) 22186013.3

(51) Int. Cl. C04B 41/48; B32B 5/02; B32B 9/00; B32B 9/04; B32B 27/40; C04B 41/00; C04B 41/45; C04B 41/63; C08G 18/40; C08G 18/42; C08G 18/48; C08G 18/67; C09D 7/40; C09D 175/08

(52) U.S. Cl. CPC C04B 41/4884; B32B 9/002; B32B 9/045; B32B 27/40; C04B 41/009; C04B 41/4596; C04B 41/63; C08G 18/4018; C08G 18/4244; C08G 18/4829; C08G 18/6755; C09D 7/70; C09D 175/08; B32B 5/022; B32B 5/024; B32B 5/026; B32B 2250/02; B32B 2260/021; B32B 2260/046; B32B 2307/718

(57) ABSTRACT

In a first aspect, the invention relates to a laminate comprising at least one layer of a layered mineralic material and a polyurethane layer, wherein the polyurethane of the polyurethane layer is obtained or obtainable from a mixture comprising the components: (i) a polyisocyanate composition; (ii) a polyol composition comprising (iia) at least one non-polar polyesterpolyol having an average difference in electronegativity ΔEN<0.38, wherein ΔEN is the sum of the differences in electronegativity (#EN) of all bonds in the non-polar polyesterpolyol divided by the total number of bonds in the non-polar polyesterpolyol. A second aspect of the invention is related to a process for preparing a laminate of the first aspect, and a third aspect is related to another process for preparing a laminate of the first aspect. In a fourth aspect, the invention relates to a laminate, obtained or obtainable from the process according to the second or the third aspect. A fifth aspect of the invention is directed to the use of the laminate according to the first aspect or of the laminate according to the fourth aspect for a wall panel, a roof panel, veneer, wall paper, kitchen surface, shower cabin, clothe, footwear, bags, automotive interior part, battery part, furniture in general, sofas, outdoor furniture, decoration.

In a first aspect, the invention relates to a laminate comprising at least one layer of a layered mineralic material and a polyurethane layer, wherein the polyurethane of the polyurethane layer is obtained or obtainable from a mixture comprising the components: (i) a polyisocyanate composition; (ii) a polyol composition comprising (iia) at least one non-polar polyesterpolyol having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol. A second aspect of the invention is related to a process for preparing a laminate of the first aspect, and a third aspect is related to another process for preparing a laminate of the first aspect. In a fourth aspect, the invention relates to a laminate, obtained or obtainable from the process according to the second or the third aspect. A fifth aspect of the invention is directed to the use of the laminate according to the first aspect or of the laminate according to the fourth aspect for a wall panel, a roof panel, veneer, wall paper, kitchen surface, shower cabin, clothe, footwear, bags, automotive interior part, battery part, furniture in general, sofas, outdoor furniture, decoration.

Mineralic materials have properties such as surface texture, which make them very interesting for various applications. For example, slate is a layered natural stone material, which is often used in roofing but also as a surface in living spaces. Significant disadvantages are however the weight and the rigidity of stone materials. Laminates comprising inorganic layers and polymeric layers are thus often the material of choice.

U.S. Pat. No. 3,287,197 describes a process for permanently cladding an inorganic surface for a time sufficient to form a mechanically permanent surface with plastic, wherein thermoplastic polymers are indicated as materials for the plastic. DE 19522875 A1 refers to a flexible sheet material having a surface layer comprising at least one layer of a multi-layered stone material, wherein this surface layer is connected by adhesion or by bonding to a flexible, tension-resistant carrier layer. The adhesion is realized by using an adhesive synthetic resin selected from the group consisting of polyolefins, vinyl polymers and copolymers, acrylate polymers, polyamides, polyesters, epoxy resins, polyurethanes and mixtures and copolymers of these substances. Regarding the polyurethanes, the document only discloses that these are made from polyisocyanates and polyols. EP 3 785 900 A1 relates to a flexible thin stone product with a stone layer and a polymer layer adjacent thereto, wherein within the polymer layer a fibrous structure is arranged. The polymer layer is formed from a 2-component polyurethane adhesive. Regarding the polyurethane, it is only disclosed that it is formed from a polyol and an isocyanate (PU NEUKADUR PN 9712 2-C polyurethane adhesive).

Mechanical splitting of slate blocks results in inflexible and rather heavy stones with a thickness of at least 4 mm. State of the art flexible slate laminates have normally a thickness of at least 1 mm and are rather stiff and only slightly flexible/bendable. Processes to produce at least flexible slate laminates are known, however, no information about chemical nature of the polymeric materials used is available. Furthermore, the processes are often done manually, and require long curing times. The polymeric materials may comprise solvents, thus it could be difficult for such a laminate to pass VDA278:2016-05 (Thermal Desorption Analysis of Organic Emissions for the Characterization of Non-Metallic Materials for Automobiles). In particular a solvent-born polymeric material may have a flashpoint below 100° C. which will lead to additional safety issues and consequently, safety measures being necessary, and additional investment costs for a production setup. The state-of-the-art polymeric material may comprise substances which are persistent, bioaccumulative and/or toxic raw materials of very high concern. In order to form a large area of a very flexible, 3-dimensional material it would be necessary to prepare a huge number of hardened, stiff, overlapping, small plate-like scales and loosely connect them as for example the skin of reptiles or pangolins. It is completely unknown, to prepare such materials from a single tarpaulin-like, extremely flexible or limp material, which would also qualify for use in clothing, comprising a slate surface.

The technical problem underlying the present invention was thus the provision of a laminate and a process for its production, which overcome the disadvantages indicated above and wherein the laminate especially should have a thickness of less than 1 mm and should be bendable, while the preparation process should enable comparatively shorter curing times.

The problem was solved according to the first aspect of the invention by a laminate comprising at least one layer of a layered mineralic material and a polyurethane layer, wherein the polyurethane of the polyurethane layer is obtained or obtainable from a mixture comprising the components:
(i) a polyisocyanate composition;
(ii) a polyol composition comprising
   (iia) at least one non-polar polyesterpolyol having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol.

The laminate is preferably a bendable laminate, which means that it is capable of being bent or flexed or twisted without breaking when a force is applied. When the force is removed, the deformation ceases to exist and the laminate can be returned to the original configuration. The force necessary to bend the laminate is so low that it is bended by its own weight. For determination of bendability (or stiffness), a specimen of a laminate is inserted into a fabric stiffness tester according to ASTM D1388 (October 2018, Cantilever Bending Length Test), a weighted slide is placed over the specimen and is advanced at a constant rate. As the leading edge of the specimen projects from the platform, it bends under its own mass. In case the deviation from the horizontal line is >1 cm at an overhang of 20 cm, the laminate is categorized as bendable.

In some preferred embodiments of the laminate, the mixture comprises ≥8 weight-% of the at least one non-polar polyesterpolyol (iia) based on the total weight of (i) and (ii) being 100 weight-%.

In some preferred embodiments of the laminate, the at least one non-polar polyesterpolyol (iia) has an average difference in electronegativity ΔEN<0.35, preferably<0.33, wherein ΔEN is the sum of the differences in electronegativity (δEN) of all bonds in the non-polar polyesterpolyol divided by the total number of bonds in the non-polar polyesterpolyol. The electronegativity difference of a bond (delta EN, δEN) is the difference in the electronegativities of the atoms involved, i.e. the atoms which are connected to each other by the bond. The δEN is known to a skilled person and is calculated for a bond based on the electronegativies of the atoms forming the bond in that the smaller EN value is subtracted from the higher EN value (see also A. L. Allred, E.G. Rochow: A scale of electronegativity based on electrostatic force. “Journal of Inorganic and Nuclear Chemistry”, 1958, DOI 10.1016/0022-1902 (58) 80003-2; A. L. Allred: Electronegativity values from thermochemical data. “Journal of Inorganic and Nuclear Chemistry”, 1961, DOI 10.1016/0022-1902(61)80142-5). Electronegativity values of all atoms, based on the Allred-Rochow scale, are known to the skilled person and can also be taken, for example, from the periodic table of elements (PTE).

For calculating the average difference in electronegativity (ΔEN) of a complete molecule, here a polyol, the δEN values of all bonds in the polyol are summed up and the resulting sum is then divided by the number of bonds in the polyol, as expressed by Equitation (1):

$$Δ EN = \frac{{\sum }_{i = 1}^{n} ( δ EN )}{n} \qquad ( 1 )$$

wherein
ΔEN is the average difference in electronegativity of the polyol,
δEN is the difference of the electronegativities of the atoms (according to the Allred-Rochow scale) of a bond in the polyol,
n is the number of all bonds in the polyol.

For calculating δEN, it is irrelevant whether the bond connecting two atoms is a single or double bond, only the difference in the electronegativity values of the involved atoms is relevant. The molecules considered have typically sp3 or sp2 carbon atoms. Thus the orientation of the bonds can be neglected. A situation where polar bonds exist but due to the linear orientation of neighboring bonds the total polarity is zero (example: CO₂) is not relevant.

Regarding ΔEN, for example, for a compound such as stearic acid methyl ester, which comprises zero hydrogen-oxygen bonds (O—H bonds), 3 carbon-oxygen bonds (C—O bonds), 38 carbon-hydrogen bonds (C—H bonds) and 17 carbon-carbon bonds (C—C bonds), wherein oxygen has an electronegativity value of 3.5, carbon has an electronegativity value of 2.5, and hydrogen has an electronegativity value of 2.2, all electronegativity values being in accordance with the PTE, ΔEN is 0.248.

There is no restriction with respect to the non-polar polyesterpolyol as long as it has ΔEN<0.38, preferably<0.35, more preferably<0.33. Methods for preparing such a non-polar polyol comprising polyester units and optionally polyether units are known to the skilled person. Per se, non-polar (hydrophobic) polyesterpolyols are reaction products of at least 2-functional acids with diols or triols. During the reaction, ester bonds are formed and water is released. For example, it is possible to blend the at least 2-functional acids with monoacids, in particular fatty acids. Alternatively, non-polar polyesterpolyols may be formed by a transesterification reaction starting from a polyesterpolyol (e.g. a tri- or diglyceride of carboxylic acids) and diols or by transamination reactions staring from polyesterpolyol and hydroxyfunctional primary or secondary amines such as diethanolamine. Branched non-polar polyesterpolyols may also be obtained by the transesterification of polyesterpolyols with 3- or 4-functional polyols. Another option are reactions involving the C—C double bonds of fatty acids or triglycerides or diglycerides of fatty acids. A very common way involves reactions of epoxidized carboxylic acids or carboxylic acid derivatives with low molecular weight diols or triols or the same reaction with tri- or digylcerides of carboxylic acids. In this case ester groups are formed and additionally ring-opening of the epoxy ring by alcohols to form ether linkages may occur. Potentially one diol or triol molecule may open multiple epoxy rings. Potentially the ring-opening of the epoxy may be done by water to form hydroxy groups. The polyesterpolyol may be synthesized in a way that several of the mentioned reactions can happen simultaneously.

Examples of non-polar polyesterpolyols are castor oils, natural oil based polyols and modified non-polar polyesterpolyols. Modification reactions include oxidation of C═C double bonds, reaction with diols or triols, epoxidation of C═C double bonds, opening of alkylenoxide rings with water (hydrolysis) or alkohols, (alcoholysis) (monools, diols, triols) or by catalytic hydrogenolysis, optionally alkoxylation of such compounds, hydroformulation followed by hydration, dimerisation, e.g. via Diels-Alder reaction and transesterification. The target of modifications is to a) form more hydroxyl groups for better incorporation into the polyurethane network, b) to modify the functionality (increase or reduce), c) to modify polarity by adding polar groups such as ethylengylcoles. All these modifications are applicable as long as the non-polar polyesterpolyol still has ΔEN<0.38, preferably<0.35, more preferably<0.33. Exemplary non-polar polyesterpolyols and methods for their preparation can be found in US 2006/041156 A1, U.S. Pat. Nos. 4,742,087 A, 6,730,768 B2 and M. Ionescu, Chemistry and Technology of polyols for polyurethanes, Rapra 2005, chapter 17 Polyols from renewable resources—oleochemical polyols. “Non-polar” and “hydrophobic” are used in the context of the present invention as synonyms.

The non-polar polyesterpolyol (iia) preferably has a functionality in the range of from 2.0 to 4.0. Preferably, the non-polar polyesterpolyol (iia) has a weight average molecular weight (Mw) in the range of from 250 to 2500 g/mol. Preferably, the non-polar polyesterpolyol (iia) has a water absorption<0.4 weight-%, more preferred<0.35 weight-%, based on the total weight of the non-polar polyesterpolyol (iia)—The polyol composition (ii) preferably has a water absorption<0.45 weight-%, more preferred<0.4 weight-%, based on the total weight of the polyol composition (ii). The value of water absorption is in each case determined according to Reference Example 5. For polyol composition (ii), the preferred or more preferred water absorption is reached, for example, by either comprising only non-polar polyesterpolyol(s) (iia) as polyol(s) (0-70 weight % filler content) or, if polyol composition (ii) comprises more weight-% of polyetherpolyol(s) than weight-% of non-polar polyesterpolyol (iia), the filler content is preferably adjusted to>25 weight-%, more preferably adjusted to>40 weight-%, optionally combined with a drying of the filler(s) before use. For a polyol composition, the total water absorption can be estimated in advance—and also adjusted or adjustable—via determining the water absorption of each of the individual components contained in the polyol composition and the individual components are then mixed in suitable (weight) amounts so that a desired water absorption of the polyol composition is achieved or achievable. Based on the determination of the water absorption of individual components and a comparision amongst each other, also suitable individual components can be selected so that a desired overall low water absorption of the polyol composition is achieved or achievable.

In some embodiments, the invention is directed to a laminate comprising at least one layer of a layered mineralic material and a polyurethane layer, wherein the polyurethane of the polyurethane layer is obtained or obtainable from a mixture comprising the components:
(i) a polyisocyanate composition;
(ii) a polyol composition comprising
   (iia) at least one non-polar polyesterpolyol having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol and/or having a water absorption<0.4 weight-%, preferably<0.35 weight-%, based on the total weight of the non-polar polyesterpolyol (iia), determined according to Reference Example 5,
   wherein preferably the polyol composition (ii) has a water absorption<0.45 weight-%, more preferred<0.4 weight-%, based on the total weight of the polyol composition (ii), determined according to Reference Example 5.

In some embodiments, the invention is directed to a laminate comprising at least one layer of a layered mineralic material and a polyurethane layer, wherein the polyurethane of the polyurethane layer is obtained or obtainable from a mixture comprising the components:
(i) a polyisocyanate composition;
(ii) a polyol composition comprising
   (iia) at least one non-polar polyesterpolyol, which preferably has an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol,
   wherein the non-polar polyesterpolyol (iia) has a water absorption<0.4 weight-%, more preferred<0.35 weight-%, based on the total weight of the non-polar polyesterpolyol (iia), determined according to Reference Example 5,
wherein preferably the polyol composition (ii) has a water absorption<0.45 weight-%, more preferred<0.4 weight-%, based on the total weight of the polyol composition (ii), determined according to Reference Example 5.

A “layered mineralic material” is characterized by strong chemical bonds between the individual substructures which form two-dimensional layers. The bonding forces within each two-dimensional layer are stronger than the interlayer-bonds between different layers. The transverse dimensions of the layers are higher than 1 mm. In contrast to two dimensional (2D) materials such as graphene, the layered mineralic material has a layer thickness higher than 1 nm. The layers are about parallelly orientated towards each other wherein “about parallelly orientated” means that two layers may be corrugated or twisted causing distortions and may form an angle in the range of from −20 to +20°.

In some preferred embodiments of the laminate, the polyol composition (ii) has a hydroxyl number in the range of from 150 to 500 mg KOH per gram of the sum of all liquid components of the polyol (ii). “Liquid” means that the component(s) is/are liquid at 25° C. and 1013 mbar, i.e. have a viscosity of less than 80000 mPas, preferred less than 25000 mPas at this temperature and pressure. In some preferred embodiments of the laminate, the polyol composition (ii) has an average functionality over all polyols contained therein in the range of from 1.8 to 3.5.

In addition to the un-polar polyesterpolyol, further isocyanate-reactive compounds can be used as part of the polyol composition (ii), preferably selected from the group of compounds having at least 1.5 isocyanate reactive groups and compounds having at least 2 isocyanate reactive groups. Substances containing at least two isocyanate reactive groups are well-known, for example “Plastics Handbook, 7, Polyurethanes”, Carl Hanser-Verlag, 3rd edition 1993, chapter 3.1.). Substances containing at least two isocyanate reactive groups may be for example polyesterpolyols, polyetherpolyols, polycarbonate polyols, polybutadienpolyols or polycaprolactone polyols. The preferred functionality of these polyols is 2 to 4, in particular 2 to 3. Preferred polyetherpolyols contain more than 50% secondary hydroxy groups, more preferred more than 75% secondary OH groups. Preferred polyesterpolyols contain more than 50% primary hydroxyl groups.

As compounds with an average of at least 1.5 isocyanate reactive groups, all compounds known in polyurethane chemistry can be used with hydrogen atoms which are reactive towards isocyanates.

The further isocyanate-reactive compounds have an average functionality of at least 1.5, preferably in the range of from 1.7 to 8, more preferably in the range of from 1.9 to 6 and more preferably in the range of from 2 to 4. These further isocyanate-reactive compounds include chain extenders and cross-linking agents with an OH functionality in the range of from 2 to 6, and a molecular weight of less than 300 g/mol, preferably a functionality in the range of from 2 to 4 and more preferably in the range of from 2 to 3, as well as higher molecular weight compounds with hydrogen atoms reactive towards isocyanate and an number average molecular weight of at least 300 g/mol.

Molecules with two hydrogen atoms reactive towards isocyanate are called chain extenders and molecules with more than two hydrogen atoms reactive towards isocyanate are called crosslinkers. Chain extender(s) and crosslinker(s) can be used individually or preferably in the form of mixtures. Preferably diamines, diols and/or triols with molecular weights of less than 300 g/mol, more preferably in the range of from 62 g/mol to less than 300 g/mol and more preferably in the range of from 62 g/mol to 250 g/mol are used. For example, aliphatic, cycloaliphatic and/or araliphatic or aromatic diamines and diols containing in the range of from 2 to 14, preferably in the range of from 2 to 10 carbon atoms can be used. Examples include diethyltoluenediamines (DEDTA), m-phenylenediamines, ethylene glycol, 1,2-propanediol, 2-methyl-1,3-propanediol, 1,3-propanediol, 1,4-butanediol, 1,6-hexanediol, 1,10-decanediol and bis-(2-hydroxyethyl)-hydroquinone (HQEE), 1,2-, 1,3-, 1,4-dihydroxycyclohexane, bisphenol-A-bis(hydroxyethyl ether), diethylene glycol, dipropylene glycol, tripropylene glycol. Further examples include triols such as 1,2,4-, 1,3,5-trihydroxycyclohexane, glycerol and trimethylolpropane, diethanolamines, triethanolamines, and low molecular weight hydroxyl group-containing polyalkylene oxides based on ethylene oxide and/or 1,2-propylene oxide and the aforementioned diols and/or triols as starter molecules. Particularly preferred crosslinkers are low molecular weight hydroxyl group-containing polyalkylene oxides based on ethylene oxide and/or 1,2-propylene oxide, more preferably 1,2-propylene, and trifunctional starters, preferably glycerol and trimethylolpropane. Particularly preferred chain extenders are selected from the group consisting of ethylene glycol, 1,2-propanediol, 1,3-propanediol, 2-methyl-1,3-propanediol, 1,4-butadiol, diethylene glycol, bis-(2-hydroxyethyl)-hydroquinone, dipropylene glycol and mixtures of two or more thereof.

If chain extenders and/or crosslinkers are used, the proportion of chain extenders and/or cross-linkers is preferably in the range of from 1 to 50, more preferably in the range of from 2 to 20 weight-%, based on the total weight of the polyol composition (ii). However, it is also possible to work without chain extender(s) and/or cross-linking agent(s). To modify the mechanical properties, e.g. the hardness, the addition of chain extenders, cross-linking agents or, if necessary, mixtures thereof may however prove advantageous.

Higher molecular weight compounds with hydrogen atoms reactive to isocyanate preferably have a number average molecular weight of 400 to 15000 g/mol. For example, compounds selected from the group of polyetherpolyols, polyesterpolyols, polytetrahydrofuran polyols, polybutadienpolyols, polycaprolactone polyols, polycarbonate polyols or mixtures thereof can be used. Polyetherpolyols are produced, for example, from epoxides, such as propylene oxide and/or ethylene oxide, or from tetrahydrofuran with hydrogen-active starter compounds, such as aliphatic alcohols, phenols, amines, carboxylic acids, water or compounds based on natural substances, such as sucrose, sorbitol or mannitol, using a catalyst. Basic catalysts or double metal cyanide catalysts may be mentioned here.

Polyesterpolyols are prepared, for example, from aliphatic or aromatic dicarboxylic acids and polyhydric alcohols, polythioetherpolyols, polyester amides, hydroxyl group-containing polyacetals and/or hydroxyl group-containing aliphatic polycarbonates, preferably in the presence of an esterification catalyst. Further possible polyols are given, for example, Plastics Handbook, 7, Polyurethanes”, Carl Hanser-Verlag, 3rd edition 1993, chapter 3.1. The polyol composition (ii) may comprise catalysts.

Common polyurethane catalysts can be used as catalysts. These catalysts greatly accelerate the reaction of compounds with hydrogen atoms (b) that are reactive towards isocyanates with the di- and polyisocyanates (a). Common catalysts which can be used for the preparation of the polyurethanes are, for example, amidines, such as 2,3-dimethyl-3,4,5,6-tetrahydropyrimidine, tertiary amines, such as triethylamine, tributylamine, dimethylbenzylamine, dime-thylcyclohexyl-amine, N-methyl-, N-ethyl-, N-cyclohexylmorpholine, N,N,N′,N′-tetramethylethylenediamine, N,N,N′,N′-tetramethyl-butanediamine, N,N,N′,N′-tetramethyl-hexanediamine, pentamethyl-diethylenetriamine, tetramethyl-diaminoethyl ether, bis-(dimethylaminopropyl)-urea, dimethylpiperazine, 1,2-dimethylimidazole, 1-aza-bicyclo-(3,3,0)-octane, and preferably 1,4-diaza-bicyclo-(2,2,2)-octane, and alkanolamine compounds such as triethanolamine, triisopropanolamine, N-methyl- and N-ethyl-diethanolamine and dimethylethanolamine. Also organic metal compounds are considered, preferably organic tin compounds, such as tin (II) salts of organic carboxylic acids, e.g. tin (II) acetate, tin (II) octoate, tin (II) ethyl hexoate and tin (II) laurate and the dialkyltin (IV) salts of organic carboxylic acids, e.g. dibutyltin (IV). e.g. dibutyltin diacetate, dibutyltin dilaurate, dibutyltin maleate and dioctyltin diacetate, as well as bismuth carboxylates, such as bismuth (III) neodecanoate, bismuth 2-ethylhexanoate and bismuth octanoate, or mixtures thereof. The organic metal compounds can be used alone or preferably in combination with strongly basic amines. If component (b) is an ester, amine catalysts are preferably used exclusively.

Catalysts (d) may be used, for example, in a concentration of 0.001 to 5weight-%, in particular 0.05 to 2weight-% as catalyst or catalyst combination, based on the weight of component (b).

Furthermore additives may be used in the polyol component (ii). All auxiliaries and additives known for the production of polyurethanes may be used. Examples include surface-active substances, foam stabilisers, cell regulators, release agents, plastizisers, fillers, dyes, pigments, flame retardants, hydrolysis inhibitors, fungistatic and bacteriostatic substances. Such substances are known and used, for example, in “Plastics Handbook, 7, Polyurethanes”, Carl Hanser-Verlag, 3rd edition 1993, chapter 3.4.4 and 3.4.6 to 3.4.11. Preferred additives are organophosphorus compounds and/or organohalogen compounds. In some preferred embodiments, the adjuvants and additives may comprise basic catalysts other than conventional polyurethane-forming catalysts. For example, these comprise polyisocyanurate-forming catalysts. Polyisocyanurate catalysts comprise alkali metal carboxylates. These preferably comprise formates and acetates, in particular acetates such as sodium acetate and potassium acetate.

Preferably, in the preparation of the polyurethane layer according to the invention, the polyisocyanate(s) of the polyisocyanate composition (i), the compounds containing hydrogen atoms reactive towards isocyanate groups and, if used, further compounds containing hydrogen atoms reactive towards isocyanate, are reacted in such quantities that the equivalence ratio of NCO groups of the polyisocyanate(s) of the polyisocyanate composition (i) to the sum of the hydrogen atoms of the other components which are reactive towards isocyanate groups is in the range of from 0.7 to 1.4, preferably in the range of from 0.8 to 1.2, more preferably in the range of from 0.9 to 1.1 and more preferably in the range of from 1.0. A ratio of 1:1 corresponds to an isocyanate index of 100.

The term “polyurethane” in the context of the present invention includes all known polyisocyanate polyaddition products. These include addition products of isocyanate and alcohol as well as modified polyurethanes which may contain isocyanurate, allophanate, urea, carbodiimide, uretonimine, biuret structures and other isocyanate addition products.

In some preferred embodiments of the laminate, the laminate comprises fibers embedded into the polyurethane layer. The polyurethane is cured in the presence of the fibers. “Embedded into the polyurethane layer” means that no part of the fibers is free and uncoated on the surface of the laminate, wherein the minimum thickness of the polyurethane layer between embedded fibers and surface is still ≥0.1 μm.

In some preferred embodiments of the laminate, the fibers are a textile or chopped fibers, wherein the textile comprises a woven textile or a non-woven textile or knitted textile or non-crimp textile and combinations of two or more thereof, wherein the textile preferably has an area weight<300 g/m², more preferably<200 g/m², more preferably in the range of from 20 to 175 g/m², more preferably in the range of from 30 to 150 g/m² and a chopped fiber has an average length in the range of from 1 to 10 mm, preferred 2 mm to 6 mm, and a diameter of 10-15 μm. The preferred fibers are glass fibers.

The material of the textile preferably comprises, more preferably is, a material selected from the group consisting of glass, carbon, polyester, aramid, polyethylene, polypropylene, polyamid, polyester-polyarylate, poly(p-phenylene-2,6-benzobisoxazole), basalt, asbestos, boron, silicium carbid, metal, natural materials such as hemp, flax, jute, kenaf, coconut, bamboo, straw, cotton, silk, wool, collagen, keratin, chitin, chitosan and mixtures thereof. All textile weave pattern known to persons skilled in the art can be considered. High air permeability and fast wetting of the textile with resin is preferred. The material of the chopped fibers comprises, more preferably is, a material selected from the group consisting of carbon, polyester, aramid, polyethylene, polypropylene, polyamid, polyester-polyarylate, poly(p-phenylene-2,6-benzobisoxazole), basalt, asbestos, boron, silicium carbid, hemp, flax, jute, kenaf, coconut, bamboo, straw, cotton, and mixtures thereof and mixtures of two or more thereof, preferably the chopped fibers are glass fibers, which have an average length in the range of from 1 to 10 mm, preferred 2 mm to 6 mm, and a diameter of 10-15 μm.

In some preferred embodiments of the laminate, the mixture comprising the components (i) and (ii) comprises >7% carbon, which is bio-based, determined according to ASTM D6866-21, in relation to the total carbon in the mixture being 100%; preferably in the range of from 7.5 to 60%, more preferably in the range of from 8.5 to 50% of carbon, which is bio-based, determined according to ASTM D6866-21, in relation to the total carbon in the mixture being 100%, preferably determined according to Reference Example 4.

In some preferred embodiments of the laminate, the mixture further comprises (iib) a dispersion, which comprises a solid filler and preferably a polyetherpolyol and/or a further polyesterpolyol.

In some preferred embodiments, the mixture consists of (i), (iia) and (iib). In some embodiments, the mixture comprises at least one non-polar polyesterpolyol (from (iia), optionally a further polyesterpolyol (from (iib)) and a polyetherpolyol (from (iib)).

In some preferred embodiments of the laminate, the filler is selected from TiO₂, carbon black, graphite, zeolite and mixtures of two or more of these fillers.

In some preferred embodiments of the laminate, the filler is selected from the group consisting of melamine, melamine cyanurate, expandable graphite, ammonum polyphosphate, aluminium oxide aluminium hydroxide, magnesium hydroxide and mixtures of two or more thereof.

In some preferred embodiments of the laminate, the dispersion (iib) is prepared by milling the filler in a polyol in the presence of a dispersing additive with a ballmill. The particle size distribution shows a d90 value smaller than 50 μm according to ISO 13320:01 2020. In some embodiments, the particle size distribution has a d90 value <4 μm.

In some preferred embodiments of the laminate, the isocyanate composition according to (i) comprises a polyisocyanate, preferably a diisocyanate, more preferably a (di) isocyanate prepolymer obtained or obtainable from a diisocyanate and polyetherpolyol. In another preferred embodiment, the isocyanate comprises a polyisocyanate.

The polyisocyanate composition (i) comprises at least one polyisocyanate (ia). The at least one polyisocyanate (ia) is an organic compound which contains at least two reactive isocyanate groups per molecule, i.e. the functionality is at least 2. The polyisocyanate composition (i) comprises one polyisocyanate or a mixture of two or more polyisocyantes. If the polyisocyanates used or the mixture do not have a uniform functionality, the number-weighted average value of the functionality of the at least one polyisocyanate (ia) is at least 2. Suitable di- and polyisocyanates have an average functionality in the range of from 2.0 to 2.9, preferably in the range of from 2.1 to 2.8. The viscosity at 23° C. according to DIN 53019-1to3 is in the range of from 5 to 1000 mPas, preferably in the range of from 10 to 600 mPas. The at least one polyisocyanate (ia) is selected from the group consisting of aliphatic, cycloaliphatic, araliphatic polyisocyanates and mixtures thereof, preferably the at least one polyisocyanate (ia), comprises at least an aromatic polyisocyanate. Such polyisocyanates are known per se or can be prepared by methods known per se. As indicated above, the polyisocyanates can in particular also be used as mixtures, so that the at least one polyisocyanate (ia) in this case contains different polyisocyanates. Preferably, the at least one polyisocyanate (ia) has two (hereinafter referred to as diisocyanates) or more than two isocyanate groups per molecule. Preferably, the at least one polyisocyanate (ia) is selected from the group consisting of alkylene diisocyanates having 4 to 12 carbon atoms in the alkylene radical, in particular 1,12-dodecanediioscyanate, 2-ethyltetramethylene diisocyanate-1,4,2-methylpentamethylene diisocyanate-1,5, tetramethylene diisocyanate-1,4, and preferably hexamethylene diisocyanate-1,6; cycloaliphatic diisocyanates, in particular cyclo-hexane-1,3- and-1,4-diisocyanate and any mixtures of these isomers, 1-isocyanato-3,3,5-tri-methyl-5-isocyanatomethylcyclohexane (IPDI), 2,4- and 2,6-hexahydrotoluylene diisocyanate and the corresponding mixtures of isomers, 4,4′-, 2,2′- and 2,4′-dicyclohexylmethane diisocyanate and the corresponding mixtures of isomers, and aromatic polyisocyanates, in particular 2, 4- and 2,6-toluylene diisocyanate and the corresponding mixtures of isomers, 4,4′-, 2,4′- and 2,2′-diphenylmethane diisocyanate and the corresponding mixtures of isomers, mixtures of 4,4′- and 2,2′-diphenylmethane diisocyanates, polyphenylpo-lymethylene polyisocyanates, mixtures of 4,4′-, 2,4′- and 2,2′-diphenylmethane diisocyanates and polyphenylpolymethylene polyisocyanates (crude MDI) and mixtures of crude MDI and toluene diisocyanates. Further preferably, the at least one polyisocyanate (ia) is selected from the group consisting of 2,2′-, 2,4′- and/or 4,4′-diphenylmethane diisocyanate (MDI), polymeric diphenylmethane diisocyanate (pMDI), 1,5-naphthylene diisocyanate (NDI), 2,4- and/or 2,6-toluylene diisocyanate (TDI),3,3′-dimethyl diphenyl diisocyanate, 1,2-diphenylethane diisocyanate and/or p-phenylene diisocyanate (PPDI), tri-, tetra-, penta-, hexa-, hepta- and/or octamethyl endiisocyanate, 2-methylpentamethylene-1,5-diisocyanate, 2-ethylbutylene-1,4-diisocyanate, penta-methylene-1,5-diisocyanate, butylene-1,4-diisocyanate, 1-isocyanato-3,3,5-trimethyl-5-iso-cyanatomethyl-cyclohexane (isophorone diisocyanate, IPDI), 1,4- and/or 1,3-bis(isocyanatomethyl)cyclohexane (HXDI), 1,4-cyclo-hexane diisocyanate, 1-methyl-2,4- and/or -2,6-cyclohexane diisocyanate and 4,4′-, 2,4′- and/or 2,2′-dicyclohexylmethane diisocyanate and mixtures of two or more of these polyisocyanates. Modified polyisocyanates, i.e. products obtained by chemical reaction of organic polyisocyanates having at least two reactive isocyanate groups per molecule, are also frequently used. Particularly mentioned are polyisocyanates containing ester, urea, biuret, allophanate, carbodiimide, isocyanurate, uretdione, carbamate and/or urethane groups. The at least one polyisocyanate (ia) may be used wholly or partly in the form of polyisocyanate prepolymers. These polyisocyanate prepolymers are obtainable by reacting the polyisocyanates of the at least one polyisocyanate (ia) described above in whole or in part in advance with polymeric compounds reactive towards isocyanates to form the isocyanate prepolymer. The reaction is carried out in excess of the at least one polyisocyanate (ia), for example at temperatures in the range from 30 to 100° C., preferably at about 80° C. Suitable polymeric compounds with groups reactive to isocyanates are known to the skilled person and are described, for example, in the “Plastics Handbook, 7, Polyurethanes”, Carl Hanser-Verlag, 3rd edition 1993, chapter 3.1. In principle, all known compounds with at least two hydrogen atoms reactive to isocyanates can be considered as polymeric compounds with groups reactive to isocyanates, for example those with a functionality in the range from 2 to 8 and a number average molecular weight Mn in the range from 400 to 15000 g/mol. For example, compounds selected from the group of polyether polyols, polyester polyols, polycarbonate polyols, polybutadienpolyols, polycaprolactone polyols, polyisocyanates and polyisocyanurates can be used. The preferred prepolymers have an NCO content in the range of from 10 to 50 weight-%, preferably in the range of from 15 to 32 weight-%.

In one preferred embodiment, the mixture, from which the polyurethane is obtained or obtainable, comprise essentially no solvent. Especially, the components (i) and (ii) comprise essentially no solvent. “Essentially no solvent” is to be understood as meaning that, apart from possibly manufacture-based impurities, they comprise no solvent and that no solvent was added to the components. The solvent content is thus below 1weight-%, preferably below 0.1weight-% and more preferably below 0.01 weight-%, based on the overall weight of the mixture being 100 weight-% and also of the components (i) and (ii). For comparison, the polyol composition of “PU NEUKADUR PN 9712 2-C polyurethane adhesive” as used in EP 3 785 900 A1 has a solvent content of 3.8 weight-% based on the total weight of the polyol composition thereof being 100 weight-% according to the safety data sheet.

The term “solvent” is common knowledge in the pertinent art. Solvent for the purposes of the present invention is to be understood in the widest sense as comprehending organic and inorganic liquids capable of dissolving other solid materials in a physical way. The prerequisite for a material to be useful as a solvent is that neither the dissolving material nor the dissolved material undergoes chemical changes in the course of the process of dissolution. Thus, the dissolved component can be recovered by physical methods of separation, such as distillation, crystallization, sublimation, evaporation and/or adsorption for example.

In the context of this invention, the mixture comprise essentially no organic solvent. In some preferred embodiments of the laminate, the mixture of (i) and (ii) comprises less than 0.1 weight-%, more preferably less than 0.01 weight-%, based on the overall weight of the mixture being 100 weight-% and also of the components (i) and (ii). More particularly the polyurethane system components comprise essentially no ether or glycol ether (such as diethyl ether, dibutyl ether, anisole, dioxane, monomeric tetrahydrofuran), ketones (such as acetone, butanone, cyclohexanone), esters (such as ethyl acetate, esters of acrylic or methacrylic acid), nitrogen compounds (such as dimethylformamide, pyridine, N-methylpyrrolidone, acetonitrile), sulfur compounds (such as carbon sulfide, dimethyl sulfoxide, sulfolane), nitro compounds (such as nitrobenzene), (hydro) halocarbons (such as dichloromethane, chloroform, tetrachloromethane, trichloroethene, tetrachloroethene, 1,2-dichloroethane, chlorofluorocarbons), hydrocarbons, preferably with boiling point above 60° C. (such as octane, methylcyclohexane, decalin, benzene, toluene, styrene, xylene).

In some preferred embodiments of the laminate, the at least one non-polar polyesterpolyol (iia) contains in the range of from zero to 25 weight-% of polyether units based on total weight of the at least one non-polar polyesterpolyol (iia). In some preferred embodiments of the laminate, the content of polyesterpolyol-units is >20 weight-% based on the total weight of all liquid components present in (i) and (ii).

In some preferred embodiments of the laminate, the at least one non-polar polyesterpolyol (iia) comprises polyesterpolyol units and optionally polyether units, wherein the content of polyesterpolyol units is in the range of from 55 to 100 weight-%, preferably in the range of from 65 to 100 weight-%, more preferably in the range of from 75 to 100 weight-%, based on the total weight of all liquid components present in (i) and (ii). The expression “liquid components” present in (i) and (ii) means all components of (i) and (ii), which are in a liquid state at 25° C. and 1013 mbar, i.e. which have a viscosity at that temperature and pressure of less than 80000 mPas. The at least one non-polar polyesterpolyol (iia) is liquid at 25° C. and 1013 mbar. In case that the at least one non-polar polyesterpolyol (iia) does not comprise polyether units, the content of polyesterpolyol units is 100 weight-%, i.e. is identical with the total weight of the at least one non-polar polyesterpolyol (iia). The content of polyesterpolyol units and of polyether units respectively in the at least one non-polar polyesterpolyol (iia), in case that polyether units are present, is determined in that the molecular weight of the at least one non-polar polyesterpolyol (iia) is taken as basis. The content of polyether units is then determined in that for each polyether unit, which derives from a polyol X comprising at least two hydroxyl groups and at least one ether bridge and which is reacted with a polyesterpolyol Y in that ether bridges are formed from the hydroxyl groups of the polyol and a suitable functional group of the polyester, for example, epoxy group(s) of the polyesterpolyol, the molecular weight of the remainder X′ of the polyol X in the at least one non-polar polyesterpolyol (iia) is determined, which corresponds to the molecular weight of the polyol X before reaction minus the molecular weight of the hydrogen atoms of the hydroxyl groups which form the ether bridges-. Furthermore, for example, ether bridges are formed by transesterification if the alcohol component contains ether groups. The molecular weight of the remainder X′ is then set into relation to the total weight of the at least one polyesterpolyol (iia) being 100 weight-%. For the polyester units, the molecular weight of the remainder Y′ of the polyesterpolyol Y in the polyesterpolyol (iia) is determined and is then set into relation to the total weight of the at least one non-polar polyesterpolyol (iia) being 100 weight-%. “At least one non-polar polyesterpolyol (iia) means that the polyesterpolyol (iia) comprises one or two or more non-polar polyesterpolyol(s).

In some preferred embodiments of the laminate, the polyisocyanate composition (i) and/or the polyol composition (ii) comprises one or more liquid and/or solid flame retardant(s).

In some preferred embodiments of the laminate, the polyol composition (ii) comprises at least 1 ppm of iron (in the form of iron cations).

In some preferred embodiments of the laminate, the layered mineralic material is preferably a layered natural stone material, more preferably selected from the group consisting of slate, mica, graphite, glimmer, layered silicates (e.g. carletonite, kaolinite, talcum), montmorillonite, molybdenium (IV) sulfate and mixtures of two or more of these layered mineralic materials, wherein the layered mineralic material preferably comprises at least slate, more preferably consists of slate. The layered mineralic material preferably comprises at least slate, more preferably consists of slate, means that the layered mineralic material comprises or consists of slate, wherein the slate itself may comprise impurities such as enclosed quartz or further materials or minerals.

In some preferred embodiments of the laminate, the layered mineralic material is cut parallel to its layered structure and where the mineralic surface intended for the production of the laminate has a roughness Rₐ (arithmetical mean height according to ISO 25178, measured according to DIN EN ISO 4287:2010-07 by Laserscanning microscope Keyence VK-X3000) of more than 1.5 μm, in particular more than 2 μm. The water content of the layered mineralic material preferably is <25 weight-%, based on the total weight of the layered mineralic material being 100 weight-%.

In some preferred embodiments, the laminate has an area weight in the range of from 500 to 1800 g/m², preferably in the range of from 900 to 1500 g/m².

In some preferred embodiments, the laminate has a thickness of less than 2 mm, preferably of less than 1.5 mm, more preferably in the range of from 0.5 to 1.0 mm, more preferably in the range of from 0.7 to 0.9 mm. In some alternative preferred embodiments, the laminate has a thickness of less than 0.3 mm, preferably in the range of from 0. 1 to 0.3 mm. Laminates having a thickness of less than 0.3 mm, preferably in the range of from 0. 1 to 0.3 mm, are preferably made with minor amounts of filler, which means less than 4 weight-% of filler, based on the total weight of the mixture being 100 weight-%. Laminates having a thickness of less than 0.3 mm are bendable based on gravitational forces only and are unstiff materials such as a tarpaulin.

### 2^{nd} Aspect—Process for Preparing a Laminate

According to a second aspect, the invention is directed to a process for preparing a laminate, preferably a laminate of the first aspect as described above, wherein the laminate comprises a layer of a layered mineralic material and at least one polyurethane layer, comprising:
(a) providing components for a mixture comprising at least
   (i) a polyisocyanate composition;
   (ii) a polyol composition comprising at least one none-polar polyesterpolyol (iia) having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol,
and mixing (i) and (ii) so that a mixture is formed;
(b) providing a three dimensional body of a layered mineralic material;
(c) applying a first layer of the mixture according to (a) on a surface of the three dimensional body of a layered mineralic material, wherein the surface is about parallelly orientated with respect to the layers of the layered mineralic material, thereby forming a layer of the mixture on the surface;
(d) applying a second layer of the mixture according to (a) on top of the first layer;
(e) optionally applying a third layer of the mixture according to (a) on top of the second layer, thereby forming an at least partially uncured laminate;
(f) curing the laminate obtained in (e), optionally at temperature above room temperature.

The mixture according to (a) is preferably applied in step (d) and (e) as long as the polyurethane system components, i.e. the mixture obtained in (b), are/is not fully cured, i.e., as long as there is still an ongoing reaction of isocyanate groups with OH groups.

In some embodiments, the invention is directed to a process for preparing a laminate, wherein the laminate comprises a layer of a layered mineralic material and at least one polyurethane layer, comprising:
(a) providing components for a mixture comprising at least
   (i) a polyisocyanate composition;
   (ii) a polyol composition comprising at least one none-polar polyesterpolyol (iia) having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol, and/or having a water absorption<0.4 weight-%, preferably<0.35 weight-%, based on the total weight of the non-polar polyesterpolyol (iia), determined according to Reference Example 5,
wherein preferably the polyol composition (ii) has a water absorption<0.45 weight-%, more preferred<0.4 weight-%, based on the total weight of the polyol composition (ii), determined according to Reference Example 5,
and mixing (i) and (ii) so that a mixture is formed;
(b) providing a three dimensional body of a layered mineralic material;
(c) applying a first layer of the mixture according to (a) on a surface of the three dimensional body of a layered mineralic material, wherein the surface is about parallelly orientated with respect to the layers of the layered mineralic material, thereby forming a layer of the mixture on the surface;
(d) applying a second layer of the mixture according to (a) on top of the first layer;
(e) optionally applying a third layer of the mixture according to (a) on top of the second layer, thereby forming an at least partially uncured laminate;
(f) curing the laminate obtained in (e), optionally at temperature above room temperature.

In some embodiments, the invention is directed to a process for preparing a laminate, wherein the laminate comprises a layer of a layered mineralic material and at least one polyurethane layer, comprising:
(a) providing components for a mixture comprising at least
   (i) a polyisocyanate composition;
   (ii) a polyol composition comprising at least one none-polar polyesterpolyol (iia) preferably having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol,
   wherein the non-polar polyesterpolyol (iia) has a water absorption<0.4 weight-%, more preferred<0.35 weight-%, based on the total weight of the non-polar polyesterpolyo (iia), determined according to Reference Example 5,
wherein preferably the polyol composition (ii) has a water absorption<0.45 weight-%, more preferred<0.4 weight-%, based on the total weight of the polyol composition (ii), determined according to Reference Example 5;
   and mixing (i) and (ii) so that a mixture is formed;
(b) providing a three dimensional body of a layered mineralic material;
(c) applying a first layer of the mixture according to (a) on a surface of the three dimensional body of a layered mineralic material, wherein the surface is about parallelly orientated with respect to the layers of the layered mineralic material, thereby forming a layer of the mixture on the surface;
(d) applying a second layer of the mixture according to (a) on top of the first layer;
(e) optionally applying a third layer of the mixture according to (a) on top of the second layer, thereby forming an at least partially uncured laminate;
(f) curing the laminate obtained in (e), optionally at temperature above room temperature.

The surface of the three dimensional body being about parallelly orientated with respect to the layers of the layered mineralic material means that the surface may be arranged in an angle within the range of from −20 to +20° with respect to at least a first layer of the layered mineralic material. Room temperature preferably means 23° C. The three dimensional body of a layered mineralic material provided according to (b) preferably has a maximum humidity of 25 weight-%: Preferably, at least (c) to (f), more preferably (a) to (f) are done at a humidity of the surrounding atmosphere, which is preferably air, of at most 45 weight-%.

### 3rd Aspect−Process for Preparing a Laminate

According to a third aspect, the invention is directed to an alternative process for preparing a laminate, preferably a laminate of the first aspect as described above, wherein the laminate comprises a layer of a layered mineralic material and at least one polyurethane layer, comprising:
(a) providing components for forming a mixture comprising at least
   (i) a polyisocyanate composition;
   (ii) a polyol composition comprising at least one non-polar polyesterpolyol (iia) having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol,
   and mixing (i) and (ii) so that a mixture is formed;
(b) providing a three dimensional body of a layered mineralic material;
(c) applying a first layer of the mixture according to (a) on a surface of the three dimensional body of a layered mineralic material, wherein the surface is about parallelly orientated with respect to the layers of the layered mineralic material, thereby forming a layer of the mixture on the surface;
(d) reacting (i) and (ii) of the mixture, thereby forming a polyurethane layer on the surface of the three-dimensional body of a layered mineralic material, which is at least partially connected to at least a first layer of the layered mineralic material;
(e) applying a second layer of the mixture according to (a) ontop of the polyurethane layer formed in (d),
(f) applying a textile layer ontop of the second layer and applying a force to embed the textile layer, wherein the applied force is preferably in the range of from 2.5 to 30 N/mm²;
(g) optionally applying a third or more layers of the mixture according to (a) ontop of the embedded textile layer of (f); thereby forming an at least partially uncured laminate;
(h) curing the laminate, optionally at temperature above room temperature.

In some embodiments, the invention is directed to a process for preparing a laminate, wherein the laminate comprises a layer of a layered mineralic material and at least one polyurethane layer, comprising:
(a) providing components for forming a mixture comprising at least
   (i) a polyisocyanate composition;
   (ii) a polyol composition comprising at least one non-polar polyesterpolyol (iia) having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol, and/or having a water absorption<0.4 weight-%, preferably<0.35 weight-%, based on the total weight of the non-polar polyesterpolyol (iia), determined according to Reference Example 5,
   wherein preferably the polyol composition (ii) has a water absorption<0.45 weight-%, more preferred<0.4 weight-%, based on the total weight of the polyol composition (ii), determined according to Reference Example 5,
and mixing (i) and (ii) so that a mixture is formed;
(b) providing a three dimensional body of a layered mineralic material;
(c) applying a first layer of the mixture according to (a) on a surface of the three dimensional body of a layered mineralic material, wherein the surface is about parallelly orientated with respect to the layers of the layered mineralic material, thereby forming a layer of the mixture on the surface;
(d) reacting (i) and (ii) of the mixture, thereby forming a polyurethane layer on the surface of the three-dimensional body of a layered mineralic material, which is at least partially connected to at least a first layer of the layered mineralic material;
(e) applying a second layer of the mixture according to (a) ontop of the polyurethane layer formed in (d),
(f) applying a textile layer ontop of the second layer and applying a force to embed the textile layer, wherein the applied force is preferably in the range of from 2.5 to 30 N/mm²;
(g) optionally applying a third or more layers of the mixture according to (a) ontop of the embedded textile layer of (f); thereby forming an at least partially uncured laminate;
(h) curing the laminate, optionally at temperature above room temperature.

In some embodiments, the invention is directed to a process for preparing a laminate, wherein the laminate comprises a layer of a layered mineralic material and at least one polyurethane layer, comprising:
(a) providing components for forming a mixture comprising at least
   (i) a polyisocyanate composition;
   (ii) a polyol composition comprising at least one non-polar polyesterpolyol (iia) preferably having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol,
   wherein the non-polar polyesterpolyol (iia) has a water absorption<0.4 weight-%, more preferred<0.35 weight-%, based on the total weight of the non-polar polyesterpolyol (iia), determined according to Reference Example 5,
   wherein preferably the polyol composition (ii) has a water absorption<0.45 weight-%, more preferred<0.4 weight-%, based on the total weight of the polyol composition (ii), determined according to Reference Example 5,
and mixing (i) and (ii) so that a mixture is formed;
(b) providing a three dimensional body of a layered mineralic material;
(c) applying a first layer of the mixture according to (a) on a surface of the three dimensional body of a layered mineralic material, wherein the surface is about parallelly orientated with respect to the layers of the layered mineralic material, thereby forming a layer of the mixture on the surface;
(d) reacting (i) and (ii) of the mixture, thereby forming a polyurethane layer on the surface of the three-dimensional body of a layered mineralic material, which is at least partially connected to at least a first layer of the layered mineralic material;
(e) applying a second layer of the mixture according to (a) ontop of the polyurethane layer formed in (d),
(f) applying a textile layer ontop of the second layer and applying a force to embed the textile layer, wherein the applied force is preferably in the range of from 2.5 to 30 N/mm²;
(g) optionally applying a third or more layers of the mixture according to (a) ontop of the embedded textile layer of (f); thereby forming an at least partially uncured laminate;
(h) curing the laminate, optionally at temperature above room temperature.

Regarding application of the mixture of (i) and (ii) to the surface of the three dimensional body of a layered mineralic material, several options are used:
The mixture of (i) and (ii) is applied to the surface of the three dimensional body of a layered mineralic material in multiple layers. The chemical composition of all layers is identical.
The mixture of (i) and (ii) is applied to the surface of the three dimensional body of a layered mineralic material in multiple layers. The chemical composition of the first layer is different from the composition of the next layer or layers.
The mixture of (i) and (ii) is applied to the surface of the three dimensional body of a layered mineralic material in multiple layers. The first layer contains no filler. The following layer or layers contain filler.

### Preferred Embodiments of the Process According to the Second Aspect as well as of the Process According to the Third Aspect

In some preferred embodiments of the process according to the second or the third aspect, the process comprises:
(i) removing the cured laminiate formed in (f) of embodiment 20 or in (h) of embodiment 21, from the three-dimensional body of layered mineralic material, therewith removing also at least the first layer of the layered mineralic material, thereby obtaining the (separated) laminate.

In some preferred embodiments of the process according to the second or the third aspect, (c) comprises:
(c.1) applying a first portion of the mixture according to (a) on a surface of the three dimensional body of a layered mineralic material, wherein the surface is about parallelly orientated with respect to the layers of the layered mineralic material, thereby forming a first layer of the mixture on the surface;
(c.2) optionally at least partially reacting (i) and (ii) of the first portion of the mixture, thereby forming a first polyurethane layer on the surface of the three-dimensional body of a layered mineralic material, which is at least partially connected to at least a first layer of the layered mineralic material;
(c.3) applying a second portion of the mixture according to (a) on the first polyurethane layer formed in (c.2), thereby forming a second layer of the mixture on the first polyurethane layer;
wherein the second and/or the first portion of the mixture according to (a) comprises fibers or wherein fibers are simultaneously applied on the surface of the three dimensional body of a layered mineralic material in (c.1) and/or in (c.3);
wherein (d) comprises reacting (i) and (ii) of the first and second portion of the mixture, thereby forming a polyurethane layer on the surface of the three-dimensional body of a layered mineralic material, which is at least partially connected to at least a first layer of the layered mineralic material.

Suitable fibers are selected from the group consisting of glass fiber, carbon fiber, polyester fiber, aramid fiber, polyethylene fiber, polypropylene fiber, polyamid fiber, polyester-polyarylate fiber, poly(p-phenylene-2,6-benzobisoxazole) fiber, basalt fiber, asbestos fiber, boron fiber, silicium carbid fiber, metal fiber, natural fibers such as hemp, flax, jute, kenaf, coconut, bamboo, straw, cotton, silk, wool, collagen, keratin, chitin, chitosan and mixtures of two or more of these fibers. Preferably, the fibers are chopped fibers and have an average length in the range of from 1 to 10 mm, preferred 2 mm to 6 mm, and a diameter of 10-15 μm. More preferably, the fibers are chopped glass fibers having an average length in the range of from 1 to 10 mm, preferred 2 mm to 6 mm, and a diameter of 10 to 15 μm. The expression “the first and second portion of the mixture according to (a) comprise fibers” means that the first portion of the mixture according to (a) comprises fibers and/or the second portion of the mixture according to (a) comprises fibers. Preferably, fibers are comprised in the first and in the second portion. The same applies for the expression that “fibers are simultaneously applied on the surface of the three dimensional body of a layered mineralic material in (c.1) and/or in (c.3)”, i.e. in (c.1) glass fibers are applied and/or in (c.3). Preferably, in both steps (c.1) and (c.3) fibers are simultaneously applied on the surface of the three dimensional body of a layered mineralic material. “Applied simultaneously” means that, for example, that fibers are mixed in situ into the first and/or the second portion of the mixture according to (a) in that, for example, the fibers are trickled into the spray jet, with which the first and/or the second portion of the mixture according to (a) is applied.

Regarding steps (c.2) and (c.3) preferably, the first polyurethane layer is partially cured, i.e. its viscosity has increased and there is still an ongoing reaction of isocyanate groups with OH groups when the second portion of the mixture according to (a) is applied in (c.3), i.e. when the second layer of the mixture on the first polyurethane layer is formed

In some preferred embodiments of the process according to the second or the third aspect, the layered mineralic material has undergone a pretreatment, wherein the surface of the pretreated layered mineralic material is more rough than the surface of the layered mineralic material before pretreatment, wherein the pretreatment is preferably selected from the group consisting of sandblasting, roughening e.g. by using coarse-grained sandpaper, and mixtures of two or more of these pretreatments.

Furthermore any additional or alternative pretreatment is suitable, which decrease the adhesion between the individual layers of the layered mineralic material. Suitable pretreatments for decreasing the adhesion are known to the skilled person.

### 4^{th} Aspect—Laminate

In a fourth aspect, the invention relates to a laminate, obtained or obtainable from the process according to the third aspect or the process according to the fourth aspect as described above in detail.

In some embodiments, the laminate described above is attached to a carrier, including post treatment/trimming, optionally pretreatment of laminate e.g. by flame treatment, plasma or Corona, adding an Adhesive, curing the multilayer-laminate, optionally above room temperature. In some embodiments, the laminate described above is attached to a carrier, including post treatment/trimming, optionally pretreatment of laminate e.g. by flame treatment, plasma or Corona, inserting the laminate into a mould or into a continuous production line, adding a resin, optionally an expandable resin, curing the multilayer-laminate optionally above room temperature. The laminate contains only minor amounts <1000 ppm, preferred<500 ppm of volatile organic substances (VOC) measured according to VDA278:2016-05. and furthermore minor amounts <1000 ppm of semi-volatile fogging compounds (FOG) according to VDA278:2016-05. For comparison, the polyol composition of “PU NEUKADUR PN 9712 2-C polyurethane adhesive” as used in EP 3 785 900 A1 has a VOC measured according to VDA278:2016-05 of 44000 ppm according to the safety data sheet.

### 5^{th} Aspect—Use

The fifth aspect of the invention is related to the use of the laminate according to the first aspect or of the laminate according to the fourth aspect for a wall panel, a roof panel, veneer, wall paper, kitchen surface, shower cabin, clothe, footwear, bags, automotive interior part, battery part, furniture in general, sofas, outdoor furniture, decoration.

The present invention is further illustrated by the following set of embodiments and combinations of embodiments resulting from the dependencies and back-references as indicated. In particular, it was noted that in each instance where a range of embodiments was mentioned, for example in the context of a term such as “any one of embodiments (1) to (4)”, every embodiment in this range was meant to be explicitly disclosed for the skilled person, i.e. the wording of this term was to be understood by the skilled person as being synonymous to “any one of embodiments (1), (2), (3) and (4)”. Further, it was explicitly noted that the following set of embodiments was not the set of claims determining the extent of protection, but represents a suitably structured part of the description directed to general and preferred aspects of the present invention.

1. A laminate comprising at least one layer of a layered mineralic material and a polyurethane layer, wherein the polyurethane of the polyurethane layer is obtained or obtainable from a mixture comprising the components:
(i) a polyisocyanate composition;
(ii) a polyol composition comprising
   (iia) at least one non-polar polyesterpolyol having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol.

2. The laminate according to embodiment 1, wherein the non-polar polyesterpolyol (iia) has a water absorption<0.4 weight-%, preferably<0.35 weight-%, based on the total weight of the non-polar polyesterpolyol (iia) and/or the polyol composition (ii) has a water absorption<0.45 weight-%, preferably<0.4 weight-%, based on the total weight of the polyol composition (ii), wherein the value of water absorption is in each case determined according to Reference Example 5.

3. The laminate according to embodiment 1 or 2, wherein the mixture comprises ≥8 weight-% of the at least one non-polar polyesterpolyol (iia) based on the total weight of (i) and (ii) being 100 weight-%.

4. The laminate according to any one of embodiments 1 to 3, wherein the at least one non-polar polyesterpolyol (iia) has an average difference in electronegativity ΔEN<0.35, preferably<0.33, wherein ΔEN is the sum of the differences in electronegativity (δEN) of all bonds in the non-polar polyesterpolyol divided by the total number of bonds in the non-polar polyesterpolyol.

5. The laminate according to any one of embodiments 1 to 4, wherein the polyol composition (ii) has a hydroxyl number in the range of from 150 to 500 mg KOH per gram of the sum of all liquid components of the polyol (ii).

6. The laminate according to any one of embodiments 1 to 5, comprising fibers embedded into the polyurethane layer.

7. The laminate according to embodiment 6, wherein the fibers are a textile or chopped fibers, wherein the textile comprises a woven textile or a non-woven textile or knitted textile or non-crimp textile and combinations of two or more thereof, wherein the textile preferably has an area weight <300 g/m², more preferably<200 g/m², more preferably in the range of from 20 to 175 g/m², more preferably in the range of from 30 to 150 g/m² and a chopped fiber has an average length in the range of from 1 to 10 mm, preferred 2 mm to 6 mm, and a diameter of 10-15 μm.

8. The laminate according to any one of embodiments 1 to 7, wherein the mixture comprising the components (i) and (ii) comprises >7% carbon, which is bio-based, determined according to ASTM D6866-21, in relation to the total carbon in the mixture being 100%; preferably in the range of from 7.5 to 60%, more preferably in the range of from 8.5 to 50% of carbon, which is bio-based, determined according to ASTM D6866-21, in relation to the total carbon in the mixture being 100%, preferably determined according to Reference Example 4.

9. The laminate according to any one of embodiments 1 to 8, wherein the mixture further comprises
(iib) a dispersion, which comprises a solid filler and preferably a polyetherpolyol and/or a further polyesterpolyol.

10. The laminate according to embodiment 9, wherein the filler is selected from TiO₂, carbon black, graphite, zeolite and mixtures of two or more of these fillers.

11. The laminate according to any one of embodiments 1 to 10, wherein the isocyanate composition according to (i) comprises a polyisocyanate, preferably a diisocyanate, more preferably a (di)isocyanate prepolymer obtained or obtainable from a diisocyanate and polyetherpolyol.

12. The laminate according to any one of embodiments 1 to 11, wherein the at least one non-polar polyesterpolyol (iia) contains in the range of from zero to 25 weight-% of polyether units based on total weight of the at least one non-polar polyesterpolyol (iia).

13. The laminate according to any one of embodiments 1 to 12, wherein the content of polyesterpolyol-units is >20 weight-% based on the total weight of all liquid components present in (i) and (ii).

14. The laminate according to any one of embodiments 1 to 13, wherein the polyisocyanate composition (i) and/or the polyol composition (ii) comprises one or more liquid and/or solid flame retardant(s).

15. The laminate according to any one of embodiments 1 to 14, wherein the polyol composition (ii) comprises at least 1 ppm of iron (in the form of iron cations).

16. The laminate according to any one of embodiments 1 to 15, wherein the layered mineralic material is preferably a layered natural stone material, more preferably selected from the group consisting of slate, mica, graphite, glimmer, layered silicates (e.g. carletonite, kaolinite, talcum), montmorillonite, molybdenium (IV) sulfate and mixtures of two or more of these layered mineralic materials, wherein the layered mineralic material preferably comprises at least slate, more preferably consists of slate.

17. The laminate according to any one of embodiments 1 to 16, wherein the layered mineralic material is cut parallel to its layered structure and where the mineralic surface intended for the production of the laminate has a roughness Ra (arithmetical mean height according to ISO 25178, measured according to DIN EN ISO 4287:2010-07 by Laserscanning microscope Keyence VK-X3000) of more than 1.5 μm, in particular more than 2 μm.

18. The laminate according to any one of embodiments 1 to 17 having an area weight in the range of from 500 to 1800 g/m², preferably in the range of from 900 to 1500 g/m².

19. The laminate according to any one of embodiments 1 to 18 having a thickness of less than 2 mm, preferably of less than 1.5 mm, more preferably in the range of from 0.5 to 1.0 mm, more preferably in the range of from 0.7 to 0.9 mm.

20. The laminate according to any one of embodiments 1 to 18 having a thickness of less than 0.3 mm, preferably in the range of from 0. 1 to 0.3 mm 21. A process for preparing a laminate, wherein the laminate comprises a layer of a layered mineralic material and at least one polyurethane layer, comprising:
(a) providing components for a mixture comprising at least
   (i) a polyisocyanate composition;
   (ii) a polyol composition comprising at least one none-polar polyesterpolyol (iia) having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol,
and mixing (i) and (ii) so that a mixture is formed;
(b) providing a three dimensional body of a layered mineralic material;
(c) applying a first layer of the mixture according to (a) on a surface of the three dimensional body of a layered mineralic material, wherein the surface is about parallelly orientated with respect to the layers of the layered mineralic material, thereby forming a layer of the mixture on the surface;
(d) applying a second layer of the mixture according to (a) on top of the first layer;
(e) optionally applying a third layer of the mixture according to (a) on top of the second layer, thereby forming an at least partially uncured laminate;
(f) curing the laminate obtained in (e), optionally at temperature above room temperature.

22. A process for preparing a laminate, wherein the laminate comprises a layer of a layered mineralic material and at least one polyurethane layer, comprising:
(a) providing components for forming a mixture comprising at least
   (i) a polyisocyanate composition;
   (ii) a polyol composition comprising at least one non-polar polyesterpolyol (iia) having an average difference in electronegativity ΔEN<0.38, wherein ΔEN is the sum of the differences in electronegativity (δEN) of all bonds in the non-polar polyesterpolyol divided by the total number of bonds in the non-polar polyesterpolyol,
and mixing (i) and (ii) so that a mixture is formed;
(b) providing a three dimensional body of a layered mineralic material;
(c) applying a first layer of the mixture according to (a) on a surface of the three dimensional body of a layered mineralic material, wherein the surface is about parallelly orientated with respect to the layers of the layered mineralic material, thereby forming a layer of the mixture on the surface;
(d) reacting (i) and (ii) of the mixture, thereby forming a polyurethane layer on the surface of the three-dimensional body of a layered mineralic material, which is at least partially connected to at least a first layer of the layered mineralic material;
(e) applying a second layer of the mixture according to (a) ontop of the polyurethane layer formed in (d),
(f) applying a textile layer ontop of the second layer and applying a force to embed the textile layer, wherein the applied force is preferably in the range of from 2.5 to 30 N/mm²;
(g) optionally applying a third or more layers of the mixture according to (a) ontop of the embedded textile layer of (f); thereby forming an at least partially uncured laminate;
(h) curing the laminate, optionally at temperature above room temperature.

23. The process according to embodiment 21 or 22 comprising:
(i) removing the cured laminiate formed in (f) of embodiment 21 or in (h) of embodiment 22, from the three-dimensional body of layered mineralic material, therewith removing also at least the first layer of the layered mineralic material, thereby obtaining the (separated) laminate.

24. The process according to any one of embodiments 21 to 23, wherein (c) comprises:
(c.1) applying a first portion of the mixture according to (a) on a surface of the three dimensional body of a layered mineralic material, wherein the surface is about parallelly orientated with respect to the layers of the layered mineralic material, thereby forming a first layer of the mixture on the surface;
(c.2) optionally at least partially reacting (i) and (ii) of the first portion of the mixture, thereby forming a first polyurethane layer on the surface of the three-dimensional body of a layered mineralic material, which is at least partially connected to at least a first layer of the layered mineralic material;
(c.3) applying a second portion of the mixture according to (a) on the first polyurethane layer formed in (c.2), thereby forming a second layer of the mixture on the first polyurethane layer;
wherein the second and/or the first portion of the mixture according to (a) comprises fibers or wherein fibers are simultaneously applied on the surface of the three dimensional body of a layered mineralic material in (c.1) and/or in (c.3);
wherein (d) comprises reacting (i) and (ii) of the first and second portion of the mixture, thereby forming a polyurethane layer on the surface of the three-dimensional body of a layered mineralic material, which is at least partially connected to at least a first layer of the layered mineralic material.

25. The process according to any one of embodiments 21 to 24, wherein the layered mineralic material has undergone a pretreatment, wherein the surface of the pretreated layered mineralic material is more rough than the surface of the layered mineralic material before pretreatment, wherein the pretreatment is preferably selected from the group consisting of sandblasting, roughening e.g. by using coarse-grained sandpaper, and mixtures of two or more of these pretreatments.

26. A laminate, obtained or obtainable from the process according to any one of embodiments 20 to 25.

27. Use of the laminate according to any one of embodiments 1 to 19 or of the laminate according to embodiment 26 for a wall panel, a roof panel, veneer, wall paper, kitchen surface, shower cabin, clothe, footwear, bags, automotive interior part, battery part, furniture in general, sofas, outdoor furniture, decoration.

The present invention is further illustrated by the following reference examples, comparative examples, and examples.

### EXAMPLES

### Materials

| | | State at 25° C. | | Water |
|---|---|---|---|---|
| Abbrevia- | | and | | absorption** |
| tion | Chemical name, composition | 1013 mbar | ΔEN* | [weight-%] |
| Polyol 1 | propoxylated glycerine, hydroxyl number | liquid | 0.431 | 2.5 |
| | 400 mg KOH/g, viscosity 400 mPa s | | | |
| | [25° C.], | | | |
| Polyol 2 | polyethylene glycole, molecular weight: | liquid | 0.475 | 2.6 |
| | 600 g/mol | | | |
| Polyol 3 | branched hydrophobic polyetherester, | liquid | 0.302 | 0.25 |
| | hydroxyl number 173 mg KOH/g | | | |
| Polyol 4 | Slightly branched hydrophobic polyether- | liquid | 0.320 | 0.25 |
| | ester, hydroxyl number 230 mg KOH/g | | | |
| Polyol 5 | propoxylated trimethylole propane, | liquid | 0.438 | 0.77 |
| | hydroxyl number 860 mg KOH/g, viscosity | | | |
| | 4900 mPa s [25° C.], | | | |
| Polyol 6 | Castor oil (85-95 weight-% triester of glyc- | liquid | 0.273 | 0.24 |
| | erol and ricinoleic acid) | | | |
| Flame | brominated aliphatic polyetherpolyol, hy- | liquid | | |
| retardent 1 | droxyl number 240 mg KOH/g | | | |
| Flame | Triethylphosphate | liquid | | |
| retardent 2 | | | | |
| Catalyst 1 | 8.5 weight-% triethanolamine, 1.5 weight- | liquid | | |
| | % diethanolamine, 1.25 triethylendiamine, | | | |
| | 3.75 weight-% 1,4-butandiol, 84.5 weight- | | | |
| | % propylene glycol-PO-EO, hydroxyl | | | |
| | number 30 mg KOH/g | | | |
| Catalyst 2 | 1 part by weight dibutylbis(do- | liquid | | |
| | decylthio)stannane in a glycerine-PO-EO | | | |
| | polyol, hydroxyl number 35 mg KOH/g | | | |
| Catalyst 3 | 56.7 weight-% triethanolamine, 10 weight- | liquid | | |
| | % diethanolamine, 8.3 weight-% triethy- | | | |
| | lendiamine, 25 weight-% 1,4-butandiol | | | |
| Dispersion | carbon black dispersion in polyetherpol- | liquid polyeth- | | |
| 1 | yol, hydroxyl number 285 mg KOH/g, vis- | erpolyol with | | |
| | cosity 1900 mPa s [20° C], 30 weight-% | dispersed solid | | |
| | solid content | carbon black | | |
| Dispersion | carbon black dispersion in polyetherpol- | liquid polyeth- | | |
| 2 | yol, hydroxyl number 210 mg KOH/g, vis- | erpolyol with | | |
| | cosity 5500 mPa s [20° C.], 30 weight-% | dispersed solid | | |
| | solid content | carbon black | | |
| Dispersion | carbon black dispersion in polyetherpol- | liquid polyeth- | | |
| 3 | yol, hydroxyl number 46 mg KOH/g, vis- | erpolyol with | | |
| | cosity 3300 mPa s [20° C.], 30 weight-% | dispersed solid | | |
| | solid content | carbon black | | |
| Dispersion | TiO₂ dispersion in polyetherpolyol, hy- | liquid polyeth- | | |
| 4 | droxyl number 15 mg KOH/g, 40 weight- | erpolyol with | | |
| | % solid content | dispersed solid | | |
| | | TiO₂ | | |
| Additive 1 | zeolite in castor oil | liquid polyes- | | |
| | | terpolyol with | | |
| | | dispersed zeo- | | |
| | | lite | | |
| Additive 2 | Xiameter ACP 1000 Antifoam Compound | liquid | | |
| Additive 3 | silicone surfactant | liquid | | |
| Additive 4 | surfactant Byk P9909 | liquid | | |
| Additive 5 | wetting agent Byk W 980 | liquid | | |
| Filler 1 | CaCO₃ | solid | | |
| Filler 2 | ATH [Al(OH)₃] | solid | | |
| Filler 3 | Chopped glass fibers, average length 3 | solid | | |
| | mm | | | |
| Isocyanat 1 | polymeric diphenylmethan-4,4-diisocya- | liquid | | |
| | nate | | | |
| Isocyanat 2 | Composition comprising 30 weight-% pol- | liquid | | |
| | ymeric diphenylmethan-4,4-diisocyanate, | | | |
| | 35 weight-% carbodiimid-modified diphe- | | | |
| | nylmethane-4,4-diisocyanat (average | | | |
| | functionality 2.2, NCO content 29.5 g/100 | | | |
| | g) 35 weight-% Isocyanate prepolymer | | | |
| | based on diphenylmethane-4,4-diisocya- | | | |
| | nate, a polyetherpolyol and dipro- | | | |
| | pylenglykole (NCO content 23 g/100 g) | | | |

*ΔEN: average difference in electronegativity of the polyol, determined according to Equitation (1):
$Δ EN = \frac{{Σ}_{i = 1}^{n} ( δ EN )}{n} \qquad ( 1 )$ wherein
ΔEN is the average difference in electronegativity of the polyol,
δEN is the difference of the electronegativities of the atoms (according to the Allred-Rochow scale) of a bond in the polyol,
n is the number of all bonds in the polyol.
**determined according to Reference Example 5

### 2. Testing Methods

Hydroxyl value (OH value, OHZ): DIN 53240-2016-03
NCO value: titration according to DIN EN ISO 14896-2009-07
Water content: titration according to DIN EN ISO 8534:2017-05 (Karl-Fischer)
Kinematic viscosity: ASTM D445-21 (25° C.)
Ratio of organic (i.e. bio-based)
carbon to total carbon: ASTM D6866-21 or ISO 16620-2-2019-10
SBI (Single burning item): DIN EN 13823-2020-09
Particle size distribution ISO 13320:01 2020

Lab test to determine laminate density or area weight of textile: cutting a rectangular specimen from a larger laminate or textile, measuring the dimensions in x, y and z-direction with a caliper and weighing the specimen or textile.

The corresponding polyol and isocyanate components were prepared separately according to the composition as shown in table 1 using a Vollrath stirrer and blending the polyol component for minimum 300 s at 1500 rpm. In the next step the polyol component was blended with the isocyanate component for 10 s at 1500 rpm in a cup. The reaction mixture was poured in a small cup (Greiner) until the cup was completely filled. When the resulting polyurethane (PU) was solid, the weight and volume are determined to calculate the pure PU density.

### Investigation of Dispersion Stability

One droplet of the dispersion was placed on a slide for microscopy studies. Olympus Stereo microscope SZX12 was used at maximum magnification. The images were analyzed visually regarding particle size (if larger than 1 μm) and potential aggregation of particles.

### Reference Example 1 Process A: Sample Preparation by Hand Lamination

A slate block was cut to a size of 25 cm×50 cm×1 cm parallel to the slate layers. It was mechanically cleaned with a metal brush followed by pressurized air treatment. Polyethylene tape was attached to the edges of the slate block to form a frame around the slate block, which was about 1 mm in height. A non-woven textile (glass mat, weight 150 g/m², Oschatz) was cut to a rectangular piece having a length of about 30 cm×and a width of about 55 cm. Polyethylene (PE) tape was applied onto both surfaces of the non-woven rectangular piece in the area of the edges of the textile to 25 cm×50 cm, so that the edge areas were covered with PE tape.

The corresponding polyol and isocyanate components were prepared separately according to the compositions as shown in table 1 below using a Vollrath stirrer and blending the polyol component, which comprises the polyol and any other component aside from the isocyanate, for minimum 300 s at 1500 rpm. In the next step, the polyol component was blended with the isocyanate component, which comprises the isocyanate, for 10 s at 1500 rpm. The reaction mixture (which should result in 55 g PU per layer) was poured on the slade block on the plane having the dimensions 25×50 cm, and evenly distributed using rolls. After a waiting time of 30 minutes, a further layer of reaction mixture was added and evenly distributed with the help of the roller. Next, the rectangular piece (25 cm×50 cm) of non-woven textile was applied on top of the reaction mixture. By using a Teflon roller, the textile was pressed into the resin in a wrinkle-free way and air was pressed out. The setup was cured at room temperature for 24 hours, allowing the reaction mixture to form a polyurethane (PU) layer. After curing, a lose end of the textile (edge area coated with PE tape) was grabbed near a corner and carefully withdrawn from the slate along the 25 cm side, this pulling off also a layer of slate that adhered to the PU. The laminate of non-woven textile, PU layer and slate layer adhering thereto was called the “laminate”. The first centimeters of the laminate were manually pressed on a pipe, diameter of 15 cm. The pipe was rolled slowly and evenly to remove the complete laminate from the slate block. After trimming and optional post-curing at 100° C. for 3 hours, the laminate was ready for attaching further materials. To prepare a facade element, the PU side of the laminate was cleaned with pressurized air. Then a waterglass or a acrylate adhesive was poured onto the PU surface and evenly distributed. A 8 mm thick piece of fiber reinforced concrete was brought into contact with the adhesive and adhesively bonded. Curing time was 7 days at room temperature.

### Reference Example 2: Process B: Sample Preparation by Spray Process

A slate block was cut to a size of 25 cm×50 cm×1 cm parallel to the slate layers. It was mechanically cleaned with a metal brush followed by pressurized air treatment. Polyethylene tape was attached to the edges of the slate block to form a frame around the slate block, which was about 1 mm in height. A woven textile (Lange+Ritter Type 1080; screen) was cut to a rectangular, having a size of 30 cm×55 cm. Polyethylene (PE) tape was applied onto both surfaces of the reactangular piece in the area of the edges, so that the edge areas were covered with PE tape. The corresponding polyol and isocyanate components were prepared separately according to the composition as shown in table 1 using a Vollrath stirrer and blending each component for minimum 300s at 1500 rpm. Polyol and isocyanate components were filled into the storage tank of the high pressure spray machine. The sample preparation was done inside a ventilated spray cabin. A reaction mixture comprising polyol and isocyanate was sprayed in a cloister on top of the slate block. After a 20 minute waiting time, a second layer was sprayed in a cloister. Then the prepared textile was pressed into the reaction mixture and the already formed/forming polyurethane (PU) resin in a wrinkle-free way. The setup was cured at room temperature for 24 hours. After curing, a lose end of the textile (edge area coated with PE tape) was grabbed near a corner and carefully withdrawn from the slate along the 25 cm side, this pulling off also a layer of slate that adhered to the PU. The laminate of woven textile, PU layer and slate layer adhering thereto was called the “laminate”. The first centimeters of the laminate were manually pressed on a pipe, diameter of 15 cm. The pipe was rolled slowly and evenly to remove the complete laminate from the slate block. After trimming and optional post-curing at 100° C. for 3 hours, the laminate was ready for attaching further materials.

### Reference Example 3: Process C: Sample Preparation by Spray Process

The polyol component was prepared in the same way as in process B. Additionally, 2weight-% of a glass fiber powder (P316-14C Lange&Ritter, 3 mm average length), was mixed into the polyol component. Then the polyurethane resin was prepared and applied to the slate in the same way as in process B. In process C, no textile was added to the reaction mixture. The setup was cured at room temperature for 24 hours. Then the laminate, comprising only PU layer and slate layer, was removed from the slate block in the same way as in process B. After trimming and optional post-curing at 100° C. for 3 hours, the laminate was ready for attaching further materials.

### Reference Example 4: Determination of Ratio of Biobased Carbon to Total Carbon

The ratio of biobased carbon in relation to total carbon (C) was determined as follows:
1) The chemical composition (formula) of each raw material was calculated based on the composition of all ingredients.
2) The total carbon content of the raw material was calculated.
3) Based on the particular molecular composition it was determined, which substructures were synthesized based on renewable raw materials (biobased) and which were based on petrochemicals.
4) Based on the raw material data, the total carbon content was calculated for each example as well as the percentual amount of carbon of petrochemical origin and carbon of biological origin (biobased carbon), followed by determination of the ratio of biobased carbon to total carbon.

The calculation was done on the level of the A components as well as A+B components.

### Reference Example 5: Determination of Water Absorption

100 g of a mixture containing 96.8 weight-% polyol, 3 weight-% additive 1 and 0.2 weight-% additive 2 were stored in a cylindrical polypropylene cup (6.5 cm diameter) for 1 h at 30° C., 70% humidity. Subsequent, the humidity was measured according to DIN EN ISO 8534:2017-05. In case of polyol mixtures, the 100 g mixture contained 96.8 weight-% polyol mixture, which comprised two or more polyols, 3 weight-% additive 1 and 0.2 weight-% additive 2 were stored for 1 h at 30° C., 70% humidity. Subsequent, the humidity was measured according to DIN EN ISO 8534:2017-05. For determination of water absorption of polyol component A as listed below in Table 1, 100 g of polyol component A [which corresponds to polyol component (ii)] were stored in an open cyclindrical PP cup (6.5 cm diameter) for 1 h at 30° C., 70% humidity. Then the cup was sealed and water content was measured by Karl-Fischer-titration according to DIN EN ISO 8534:2017-05.

### Comparative Examples and Examples

Comparative Examples 1-3 and Inventive Examples 1-4 were prepared according to the procedures described above in Reference Examples 1 to 3, the compositions, procedures used and resulting properties are listed in Table 1. Parts of the polyols as indicated in Table 1 were “bio-based”, i.e. these polyols or parts thereof were obtained by fermentation, by enzymatic modification or chemical modification of underlying bioproducts.

TABLE 1

| | | | | Comparative | |
|---|---|---|---|---|---|
| | | Comparative | Comparative | Example | |
| | | Example 1 | Example 2 | 3 | Example 1 |
| | Process A | yes | Yes | Yes | Yes |
| | Process B | No | No | No | Yes |
| | Process C | No | No | No | No |
| A | Polyol 1 [weight-%] | 39.7 | 7.5 | 7.5 | 0 |
| | Polyol 2 [weight-%] | 40.8 | 24.8 | 24.8 | 0 |
| | Polyol 3 [weight-%] | 0 | 0 | 0 | 12.4 |
| | Polyol 4 [weight-%] | 0 | 0 | 0 | 3 |
| | Polyol 5 [weight-%] | 0 | 0 | 0 | 1.5 |
| | Polyol 6 [weight-%] | 0 | 0 | 0 | 0 |
| | Flame retardent 1 | 0 | 0 | 0 | 8.9 |
| | [weight-%] | | | | |
| | Flame retardent 2 | 0 | 0 | 0 | 1.1 |
| | [weight-%] | | | | |
| | Additive 1 | 5.4 | 4.7 | 4.7 | 4 |
| | [weight-%] | | | | |
| | Additive 2 | 1.1 | 0.9 | 0.9 | 1 |
| | [weight-%] | | | | |
| | Additive 3 | 0 | 0.9 | 0.9 | |
| | [weight-%] | | | | |
| | Additive 4 | 5 | 0.9 | 0.9 | |
| | [weight-%] | | | | |
| | Additive 5 | 0 | 0 | 0 | 0.5 |
| | [weight-%] | | | | |
| | Catalyst 1 | 1.1 | 0 | 0 | 0.6 |
| | [weight-%] | | | | |
| | Catalyst 2 | 0 | 0 | 0 | 0 |
| | [weight-%] | | | | |
| | Catalyst 3 | 0 | 0 | 0 | 0 |
| | [weight-%] | | | | |
| | Dispersion 1 | 1.5 | 1.5 | 0 | 1.5 |
| | [weight-%] | | | | |
| | Dispersion 2 | 0 | 0 | 0 | 0 |
| | [weight-%] | | | | |
| | Dispersion 3 | 0 | 0 | 1.5 | 0 |
| | [weight-%] | | | | |
| | Dispersion 4 | 5.4 | 3.5 | 3.5 | 3.5 |
| | [weight-%] | | | | |
| | Filler 1 [weight-%] | 0 | 59.6 | 59.6 | 0 |
| | Filler 2 [weight-%] | 0 | | | 62 |
| | Filler 3 [weight-%] | 0 | | | |
| | A Total | | 100 | 100 | 100 |
| | [weight-%] | | | | |
| | Density Polyol [g/l] | — | 1450 | 1450 | 1700 |
| B | Isocyanate 1 | 61.2 | 17.8 | 17.8 | 0 |
| | [weight-% based on | | | | |
| | 100 weight-% of A] | | | | |
| | Isocyanate 2 | 0 | 0 | 0 | 23.1 |
| | [weight-% based on | | | | |
| | 100 weight-% of A] | | | | |
| | Mixing ratio 100: | 61.2 | 24.7 | 24.7 | 23.1 |
| | Iso Index | 100 | 122.7 | 122.7 | 100 |
| | Density PU [g/l] | 240 | 1260 | 1260 | 1450 |
| | Polyetherpolyol | 50.0 | 25.9 | 25.9 | 9.7 |
| | content* | | | | |
| | Polyesterpolyol | 0 | 0 | 0 | 12.5 |
| | content* | | | | |
| | Polyesterpolyol | 0 | 0 | 0 | 25.2 |
| | content* (ignoring | | | | |
| | filler) | | | | |
| | Filler content** | 0 | 48 | 48 | 50 |
| | ratio biobased Carbon | 5.625 | 7.017 | 6.785 | 27.198 |
| | content to total | | | | |
| | C*** [%] | | | | |
| | Water absorption of | 0.56 | 0.7 | — | — |
| | A**** | | | | |
| | [weight-%] | | | | |
| | Textile, area weight | 50 | 50 | 50 | 50 |
| | [g/m²] | | | | |
| | Laminate, area | 310 | 1190 | 1190 | 1390 |
| | weight [g/m²] | | | | |
| | (Process A) | | | | |
| | Laminate, Area | — | — | — | 1370 |
| | weight [g/m²] | | | | |
| | (Process B) | | | | |
| | Laminate, Area | — | — | — | — |
| | weight [g/m²] | | | | |
| | (Process C) | | | | |
| | Laminate removal | Cohesive failure | Adhesive failure | Adhesive | Cohesive failure |
| | from slate | in | between | failure | in slate |
| | | foamed PU | slate and PU | between slate | material, |
| | | layer | layer | and PU | resulting in |
| | | | | layer | laminate |
| | | | | | comprising |
| | | | | | textile, PU |
| | | | | | and slate |
| | | | | | layer |
| | Laminate quality | No slate removed | No slate removed | No slate removed | 0.8 mm thick |
| | | | | | perfect laminate |
| | SBI test result (EN | — | — | — | Cs1d0 |
| | 13823, DIN EN | | | | |
| | 13501-1) | | | | |

| | | Example 2 | Example 3 | Example 4 | Example 5 |
|---|---|---|---|---|---|
| | Process A | Yes | No | Yes | Yes |
| | Process B | Yes | no | Yes | No |
| | Process C | No | Yes | No | No |
| A | Polyol 1 [weight-%] | 0 | 0 | 0 | 0 |
| | Polyol 2 [weight-%] | 0 | 0 | 0 | 0 |
| | Polyol 3 [weight-%] | 11.1 | 10.7 | 58.48 | 0 |
| | Polyol 4 [weight-%] | 2.5 | 2.4 | 18.1 | 0 |
| | Polyol 5 [weight-%] | 1.5 | 1.5 | 9.7 | 9.4 |
| | Polyol 6 [weight-%] | 0 | 0 | 0 | 73.7 |
| | Flame retardent 1 | 6.8 | 6.6 | 0 | 0 |
| | [weight-%] | | | | |
| | Flame retardent 2 | 1.1 | 1.1 | 0 | 0 |
| | [weight-%] | | | | |
| | Additive 1 | 4 | 3.9 | 5 | 7.7 |
| | [weight-%] | | | | |
| | Additive 2 | 1 | 1 | 1 | 1 |
| | [weight-%] | | | | |
| | Additive 3 | | 0 | 0 | 0 |
| | [weight-%] | | | | |
| | Additive 4 | | 0 | 0 | 0 |
| | [weight-%] | | | | |
| | Additive 5 | 0.5 | 0.5 | 0 | 0 |
| | [weight-%] | | | | |
| | Catalyst 1 | 0.5 | 0.5 | 0 | 1.7 |
| | [weight-%] | | | | |
| | Catalyst 2 | 0 | 0 | 0.4 | 0 |
| | [weight-%] | | | | |
| | Catalyst 3 | 0 | 0 | 0.12 | 0 |
| | [weight-%] | | | | |
| | Dispersion 1 | 1.5 | 1.5 | 1.5 | 1.5 |
| | [weight-%] | | | | |
| | Dispersion 2 | 0 | 0 | 0 | 0 |
| | [weight-%] | | | | |
| | Dispersion 3 | 0 | 0 | 0 | 0 |
| | [weight-%] | | | | |
| | Dispersion 4 | 3.5 | 3.4 | 5 | 5 |
| | [weight-%] | | | | |
| | Filler 1 [weight-%] | 0 | 0 | 0 | 0 |
| | Filler 2 [weight-%] | 66 | 63.9 | | 0 |
| | Filler 3 [weight-%] | | 3 | | 0 |
| | A Total | 100 | 100 | 100 | 100 |
| | [weight-%] | | | | |
| | Density Polyol [g/l] | 1800 | 1800 | 1150 | 1140 |
| B | Isocyanate 1 | 0 | 0 | 0 | 0 |
| | [weight-% based on | | | | |
| | 100 weight-% of A] | | | | |
| | Isocyanate 2 | 20.3 | 20.3 | 66 | 57.2 |
| | [weight-% based on | | | | |
| | 100 weight-% of A] | | | | |
| | Mixing ratio 100: | 20.3 | 20.3 | 66 | 57.2 |
| | Iso Index | 100 | 100 | 100 | 100 |
| | Density PU [g/l] | 1530 | 1550 | 1060 | 915 |
| | Polyetherpolyol | 7.7 | 7.5 | 10.9 | 14.4 |
| | content* | | | | |
| | Polyesterpolyol | 11.3 | 10.9 | 46.1 | 77.6 |
| | content* | | | | |
| | Polyesterpolyol | 25 | 23.2 | 46.1 | 77.6 |
| | content* (ignoring | | | | |
| | filler) | | | | |
| | Filler content** | 55 | 56 | 0 | 0 |
| | ratio biobased Carbon | 27.797 | 27.259 | 38.613 | 43.784 |
| | content to total | | | | |
| | C*** [%] | | | | |
| | Water absorption of | 0.07 | — | 0.11 | 0.1 |
| | A**** | | | | |
| | [weight-%] | | | | |
| | Textile, area weight | 50 | None | 50 | 50 |
| | [g/m²] | | | | |
| | Laminate, area | 1470 | — | 950 | — |
| | weight [g/m²] | | | | |
| | (Process A) | | | | |
| | Laminate, Area | 1450 | — | 930 | — |
| | weight [g/m²] | | | | |
| | (Process B) | | | | |
| | Laminate, Area | — | 1450 | — | — |
| | weight [g/m²] | | | | |
| | (Process C) | | | | |
| | Laminate removal | Cohesive | Cohesive | Cohesive | Cohesive failure |
| | from slate | failure in | failure in | failure in | in slate |
| | | slate material, | slate material, | slate | material, |
| | | resulting | resulting | material | resulting in |
| | | in laminate | in laminate | resulting in | laminate |
| | | comprising | comprising | laminate | comprising |
| | | textile, | PU | comprising | textile, PU |
| | | PU and | layer and | textile, | and slate |
| | | slate layer | slate layer | PU and | layer |
| | | | | slate layer | |
| | Laminate quality | 0.8 mm | 0.8 mm | 0.8 mm | 0.7 mm thick |
| | | thick perfect | thick perfect | thick | laminate, |
| | | laminate | laminate | perfect | less than 5% |
| | | | | laminate | of surface |
| | | | | | area have small |
| | | | | | defects = |
| | | | | | locally no |
| | | | | | slate |
| | SBI test result (EN | Bs1d0 | Bs1d0 | Es2d0 | — |
| | 13823, DIN EN | | | | |
| | 13501-1) | | | | |

*% based on sum of all polyols used in A and B being 100%.
**% based on the sum of all fillers used in A and B being 100%
***% based on all carbon being present being 100%, wherein the determination was made based on the data shown in Table 2 and with the calculation according to Reference Example 4.
****determined according to Reference Example 5

TABLE 2
Data for calculation of ratio of biobased carbon content to total C

| | | Comparative | Comparative | Comparative | | | | | |
|---|---|---|---|---|---|---|---|---|---|
| | | Example 1 | Example 2 | Example 3 | Example 1 | Example 2 | Example 3 | Example 4 | Example 5 |
| total C content | [%] | 52.187 | 22.112 | 22.239 | 20.350 | 18.045 | 17.538 | 61.568 | 61.781 |
| (A component) | | | | | | | | | |
| bio based C | [%] | 5.421 | 2.453 | 2.381 | 10.171 | 9.180 | 8.864 | 42.579 | 45.515 |
| (A component) | | | | | | | | | |
| ratio bio-based C to | [%] | 10.388 | 11.096 | 10.706 | 49.980 | 50.872 | 50.541 | 69.157 | 73.671 |
| total C (A component) | | | | | | | | | |
| total C content | [%] | 44.186 | 12.852 | 12.852 | 17.045 | 14.979 | 14.979 | 48.701 | 42.171 |
| (B component) | | | | | | | | | |
| bio based C | | 0.000 | 0.000 | 0.000 | 0.000 | 0.000 | 0.000 | 0.000 | 0.000 |
| (B component) | | | | | | | | | |
| total C content | [%] | 96.374 | 34.963 | 35.091 | 37.395 | 33.024 | 32.517 | 110.269 | 103.952 |
| (A + B component) | | | | | | | | | |
| bio-based C content | [%] | 5.421 | 2.453 | 2.381 | 10.171 | 9.180 | 8.864 | 42.579 | 45.515 |
| (A + B component) | | | | | | | | | |
| ratio bio-based C to | [%] | 5.625 | 7.017 | 6.785 | 27.198 | 27.797 | 27.259 | 38.613 | 43.784 |
| total C (A + B | | | | | | | | | |
| component) | | | | | | | | | |

Regarding the ratio of biobased carbon content to total C, the comparative examples based on polyetherpolyols had a ratio of biobased carbon to total carbon in the range of from 10 to 12% (A component). The corresponding values for the inventive examples were in the range of from 49 to 51% (filled systems, Examples 1 to 3) and in the range of from 50 to 75% (unfilled system, Examples 4 and 5).

When the calculation was based on the total amount of resin (A+B component) the ratio of biobased to total carbon was in the range of from 5 to 7.5% for the comparative examples and in the range of from 27 to 28% (filled systems, Examples 1 to 3) and in the range of from 38 to 44% (unfilled system, Examples 4 and 5) respectively.

It was observed, that a polyetherpolyol-based formulation without fillers (Comparative Example 1) resulted in strong foaming. Thus, a layer of composition/reaction mixture applied with a thickness of 1 mm resulted in a thickness of 5 mm after curing. It was not possible to remove a laminate with slate as there was a cohesive failure in the PU foam layer. If CaCO₃ was added to the same formulation (Comparative Example 2), there was less foaming and it was not possible to remove laminate with slate. An adhesive failure between the slate and the PU layer was observed. If the dispersion was changed, no difference was observed (Comparative Example 3).

A different formulation concept based on hydrophobic polyetherester polyols resulted in a successful removal of a laminate with PU layer and slate layer after full curing, both with and without fillers (Examples 1 to 5).

### Example 6: Influence of Surface Roughness of the Layered Mineralic Material

3 pieces of slate have been used for sample preparation. At the start, the roughness Ra (arithmetical mean height according to ISO25178, measured according to DIN EN ISO 4287-2010-07 by Laserscanning microscope Keyence VK-X3000) of the slate samples was measured.
Sample A, untreated: surface roughness Ra=3.76 μm (by analysis of 5 spots on a 4000 μm sized sample)
Sample B, after coarse polishing: surface roughness Ra=1.94 μm (by analysis of 5 spots on a 4000 μm sized sample)
Sample C, after fine polishing: surface roughness Ra=1.12 μm (by analysis of 5 spots on a 4000 μm sized sample)

All laminates were prepared using the formulation of example 1 and process A. After the preparation the thickness of the slate layer was measured by microscope analysis. Sample A: 80 μm slate layer, sample B: 35 μm slate layer, sample C: 15 μm slate layer.

### Example 7: Determination of Bendability or Stiffness of Laminates

Several slate laminates have been prepared according to example 4 and process A (F2 to F6 and example 4 and process B (F1). The samples were cut into stripes, then a cantilever bending length test according to ASTM D1388 (October 2018) was done. At 20 cm overhang length, the overhang height was measured.

TABLE 3
overhang of selected laminates

| | | |
|---|---|---|
| Sample | Laminate thickness | Overhang height |

| | | | |
|---|---|---|---|
| Slade block, 8 mm | — | 0.0 | cm |

| | | | | |
|---|---|---|---|---|
| Sample F1 | 0.2 | mm | 19.4 | cm |
| Sample F2 | 0.5 | mm | 12.6 | cm |
| Sample F3 | 0.5 | mm | 14.0 | cm |
| Sample F4 | 1 | mm | 3.8 | cm |
| Sample F5 | 0.5 | mm | 18.4 | cm |
| Sample F6 | 0.5 | mm | 18.0 | cm |
| Sample F7 | 1 | mm | 3.7 | cm |
| Sample F8 | 1 | mm | 4.4 | cm |
| Sample F9 | 2 | mm | 1.7 | cm |
| Sample F10 | 1 | mm | 1.6 | cm |
| Sample F11 | 2 | mm | 1.7 | cm |
| Sample F12 | 2 | mm | 1.3 | cm |
| Sample F13 | 2 | mm | 1.7 | cm |
| Sample F14 | 2 | mm | 1.1 | cm |
| Sample F15 | 4 | mm | 3.3 | cm |
| Sample F16 | 1.5 | mm | 1.5 | mm |
| Sample F17 | 1 | mm | 1.8 | mm |
| Sample F18 | 2 | mm | 1.2 | mm |

The overhang height depends on pretreatments, the composition of the laminate (fibers, fiber length etc.), the thickness of the laminate and, of course, on the nature of the layered material. As slate and other layered mineralic materials are natural materials, their properties can vary and strongly depend on the location they were quarried. Slate and layered mineralic materials differ for example regarding composition, color, homogeneity, impurities, crystallinity, maximum block size depending on their origin. However, it was shown that the overhang height was always at least >1 cm. Consequently, all laminates tested could be considered as bendable laminates.

### Cited Literature

U.S. Pat. No. 3,287,197
DE 19522875 A1
EP 3 785 900 A1
A. L. Allred, E. G. Rochow: A scale of electronegativity based on electrostatic force. “Journal of Inorganic and Nuclear Chemistry”, 1958, DOI 10.1016/0022-1902(58)80003-2
A. L. Allred: Electronegativity values from thermochemical data. “Journal of Inorganic and Nuclear Chemistry”, 1961, DOI 10.1016/0022-1902(61)80142-5)
US 2006/041156 A1
U.S. Pat. No. 4,742,087 A
U.S. Pat. No. 6,730,768 B2
M. Ionescu, Chemistry and Technology of polyols for polyurethanes, iSmithers Rapra Publishing, 2005, chapter 17 Polyols from renewable resources—oleochemical polyols
“Plastics Handbook, 7, Polyurethanes”, Carl Hanser-Verlag, 3rd edition 1993, chapter 3.1
“Plastics Handbook, 7, Polyurethanes”, Carl Hanser-Verlag, 3rd edition 1993, chapter 3.4.4 and 3.4.6 to 3.4.11.

1. A laminate, comprising at least one layer of a layered mineralic material and a polyurethane layer, wherein the polyurethane of the polyurethane layer is obtained from a mixture comprising:
(i) a polyisocyanate composition; and
(ii) a polyol composition comprising:
(iia) at least one non-polar polyesterpolyol having an average difference in electronegativity ΔEN<0.38, wherein ΔEN is a sum of differences in electronegativity (δEN) of all bonds in the non-polar polyesterpolyol divided by a total number of bonds in the non-polar polyesterpolyol.

2. The laminate according to claim 1, wherein the non-polar polyesterpolyol (iia) has a water absorption<0.4 weight-%, based on a total weight of the non-polar polyesterpolyol (iia) and/or the polyol composition (ii) has a water absorption<0.45 weight-%, based on the total weight of the polyol composition (ii).

3. The laminate according to claim 1, wherein the non-polar polyesterpolyol (iia) has an average difference in electronegativity ΔEN<0.35.

4. The laminate according to claim 1, wherein the polyol composition (ii) has a hydroxyl number of 150 to 500 mg KOH per gram of a sum of all liquid components of the polyol composition (ii).

5. The laminate according to claim 1, comprising fibers embedded in the polyurethane layer.

6. The laminate according to claim 5, wherein:
the fibers are a textile or chopped fibers;
the textile comprises a woven textile, a non-woven textile, a knitted textile, a non-crimp textile, of a combination of two or more thereof;
the textile has an area weight <300 g/m²; and
a chopped fiber has an average length of 1 to 10 mm.

7. The laminate according to claim 1, wherein the mixture comprising the components (i) and (ii) comprises >7% carbon, which is bio-based, determined according to ASTM D6866-21, based on 100% total carbon in the mixture.

8. The laminate according to claim 1, further comprising:
(iib) a dispersion, which comprises a solid filler.

9. The laminate according to claim 1, wherein the non-polar polyesterpolyol (iia) contains zero to 25 weight-% of polyether units based on a total weight of the non-polar polyesterpolyol (iia).

10. The laminate according to claim 1, wherein:
the mixture comprises ≥8 weight-% of the non-polar polyesterpolyol (iia) based on a total 100 weight-% of (i) and (ii); and/or
a content of polyesterpolyol-units is >20 weight-% based on a total weight of all liquid components present in (i) and (ii).

11. The laminate according to claim 1, wherein the layered mineralic material is a layered natural stone material.

12. A process for preparing a laminate,
(a) applying a first layer of a mixture to a surface of a three dimensional body of a layered mineralic material, wherein the surface is about parallel to layers of the layered mineralic material, to form a layer of the mixture on the surface;
(b) applying a second layer of the mixture on top of the first layer to form an at least partially uncured laminate;
(c) optionally applying a third layer of the mixture on top of the second layer; and
(d) curing the partially uncured laminate;
wherein:
the mixture comprises:
(i) a polyisocyanate composition; and
(ii) a polyol composition comprising at least one non-polar polyesterpolyol (iia) having an average difference in electronegativity ΔEN<0.38, wherein ΔEN is a sum of differences in electronegativity (δEN) of all bonds in the non-polar polyesterpolyol divided by a total number of bonds in the non-polar polyesterpolyol.

13. A process for preparing a laminate,
(a) applying a first layer of a mixture to a surface of a three dimensional body of a layered mineralic material, wherein the surface is about parallel to layers of the layered mineralic material, to form a layer of the mixture on the surface, the mixture comprising: (i) a polyisocyanate composition, and (ii) a polyol composition comprising at least one non-polar polyesterpolyol (iia) having an average difference in electronegativity ΔEN<0.38, wherein ΔEN is a sum of differences in electronegativity (ΔEN) of all bonds in the non-polar polyesterpolyol divided by a total number of bonds in the non-polar polyesterpolyol;
(b) reacting (i) and (ii) of the mixture to form a polyurethane layer on the surface of the three-dimensional body of a layered mineralic material, such that the polyurethane layer is at least partially connected to at least a first layer of the layered mineralic material;
(c) applying a second layer of the mixture to the polyurethane layer;
(d) applying a textile layer to the second layer and applying a force to form an embedded textile layer to form an at least partially uncured laminate;
(e) optionally applying a third or more layers of the mixture to the embedded textile layer; and
(f) curing the laminate.

14. A laminate, obtained by the process according to claim 12.

15. A component, comprising the laminate according to claim 1, wherein the component is selected from the group consisting of a wall panel, a roof panel, a veneer, wallpaper, a kitchen surface, a shower cabin, a cloth, footwear, a bag, an automotive interior part, a battery part, furniture, and a decoration.

16. A laminate, obtained by the process according to claim 13.
